(19) United States
(12) Patent Application Publication
(10) Pub. No.: US 2026/0001293 A1
(43) Pub. Date: Jan. 1, 2026

(54) MESH STRUCTURE AND METHOD OF MANUFACTURE

(71) Applicant: Lear Corporation, Southfield, MI (US)

(72) Inventors: Ibrahim VALENZUELA, Novi, MI (US); Haifeng LIU, Novi, MI (US); Lisa SWIKOSKI, West Bloomfield, MI (US); Kevin M. GEISLER, Menlo Park, CA (US); Michelle A. BRUDZYNSKY, Farmington Hills, MI (US); Curtis HUDSON, Macomb, MI (US); Jaiviknesh KANDASAMY, Farmington Hills, MI (US); Paul SEVERINSKI, Brownstown, MI (US); Christopher D. JOHNSON, Novi, MI (US); William WEBSTER, Millington, MI (US); David KAZYAK, Brighton, MI (US); Jeanene F. MUNROE, Southfield, MI (US); Joshua HALLOCK, Warren, MI (US); Samuel BLAIR, Troy, MI (US); David ABDELLA, Royal Oak, MI (US)

(73) Assignee: Lear Corporation, Southfield, MI (US)

(21) Appl. No.: 18/877,717

(22) PCT Filed: Jun. 21, 2023
(86) PCT No.: PCT/US2023/025883

§ 371 Date: Dec. 20, 2024

Related U.S. Application Data
(60) Provisional application No. 63/354,288, filed on Jun. 22, 2022.
(60) Provisional application No. 63/355,785, filed on Jun. 27, 2022.
(60) Provisional application No. 63/356,719, filed on Jun. 29, 2022.

(30) Foreign Application Priority Data
Apr. 21, 2023 (DK) PA202370186

(51) Int. Cl. B29D 99/00; B29K 101/12

(52) U.S. Cl. CPC B29D 99/0092; B29K 2101/12

(57) ABSTRACT

A filament mesh structure, methods of manufacture and forming the filament mesh structure, and seat assembly having the filament mesh structure. The filament mesh structure may be cut by a fluid jet, may be heated with fluid to facilitate reshaping, or both. The filament mesh structure may be provided with a foldable connecting segment that facilitates folding of the filament mesh structure.

### CROSS-REFERENCE TO RELATED APPLICATIONS

This application claims the benefit of Denmark patent application no. PA202370186, filed Apr. 21, 2023, which in turn claims priority to U.S. provisional application Ser. No. 63/354,288, filed Jun. 22, 2022, U.S. provisional application Ser. No. 63/355,785, filed Jun. 27, 2022, and U.S. provisional application Ser. No. 63/356,719, filed Jun. 29, 2022, the disclosures of which are hereby incorporated in their entirety by reference herein.

### TECHNICAL FIELD

Various embodiments relate a filament mesh structure, such as cushion, a seat assembly having a filament mesh structure cushion, and one or more methods of manufacture and forming the filament mesh structure.

### BRIEF DESCRIPTION OF THE DRAWINGS

FIG. 1 is a perspective view of an example of a seat assembly.

FIG. 2 is a perspective view of an example of a cushion comprising a filament mesh structure that can be provided with a seat assembly.

FIG. 3 is schematic view of an example of a manufacturing system for making the filament mesh structure.

FIG. 4 is a perspective view of an example of a cutting system for cutting the filament mesh structure.

FIGS. 5A-5G show schematic side views of various cuts that can be made with the cutting system.

FIGS. 6A and 6B show schematic top views of various cuts that can be made with the cutting system.

FIG. 7 illustrates an example of a forming system for forming the filament mesh structure with a forming tool shown in a retracted position.

FIG. 8 illustrates the forming system of FIG. 7 with steam being sprayed onto the filament mesh structure.

FIG. 9 illustrates the forming system of FIG. 7 with the forming tool engaged with the filament mesh structure.

FIG. 10 illustrates the forming system of FIG. 7 after reshaping the filament mesh structure and with the forming tool in the retracted position.

FIG. 11 is a perspective view of another example of a forming system for forming a filament mesh structure with the forming tool engaged with the filament mesh structure to reshape the filament mesh structure.

FIG. 12 is a section view along section line 12-12 with the forming tool prior to engaging the filament mesh structure with steam being sprayed.

FIG. 13 is a perspective view of another example of a forming system for forming a filament mesh structure in which steam is sprayed by a nozzle to reshape the filament mesh structure.

FIG. 14 is a magnified view of a portion of a filament mesh structure showing an example of filaments before being heated and reshaped.

FIG. 15 is a magnified view of the portion of the filament mesh structure in FIG. 14 showing an example of filaments after being heated and reshaped.

FIG. 16 is a flowchart of a method of forming a filament mesh structure that is associated with the forming system configurations shown in FIGS. 7-13.

FIGS. 17 and 18 are top and side views of an example of a piece of the filament mesh structure.

FIGS. 19 and 20 are top and side views of the filament mesh structure of FIGS. 17 and 18 after shaping.

FIGS. 21 and 22 are top and side views of the filament mesh structure of FIGS. 19 and 20 after folding.

FIG. 23 is a side view of the filament mesh structure of FIG. 22 with folded portions of the filament mesh structure secured in folded positions.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if”' is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Moreover, except where otherwise expressly indicated, all numerical quantities in this description and in the claims are to be understood as modified by the word “about” in describing the broader scope of this invention. The term “substantially,” “generally,” or “about” may be used herein and may modify a value or relative characteristic disclosed or claimed. In such instances, “substantially,” “generally,” or “about” may signify that the value or relative characteristic it modifies is within ±0%, 0.1%, 0.5%, 1%, 2%, 3%, 4%, 5% or 10% of the value or relative characteristic. Practice within the numerical limits stated is generally preferred. Also, unless expressly stated to the contrary, the description of a group or class of materials by suitable or preferred for a given purpose in connection with the invention implies that mixtures of any two or more members of the group or class may be equally suitable or preferred.

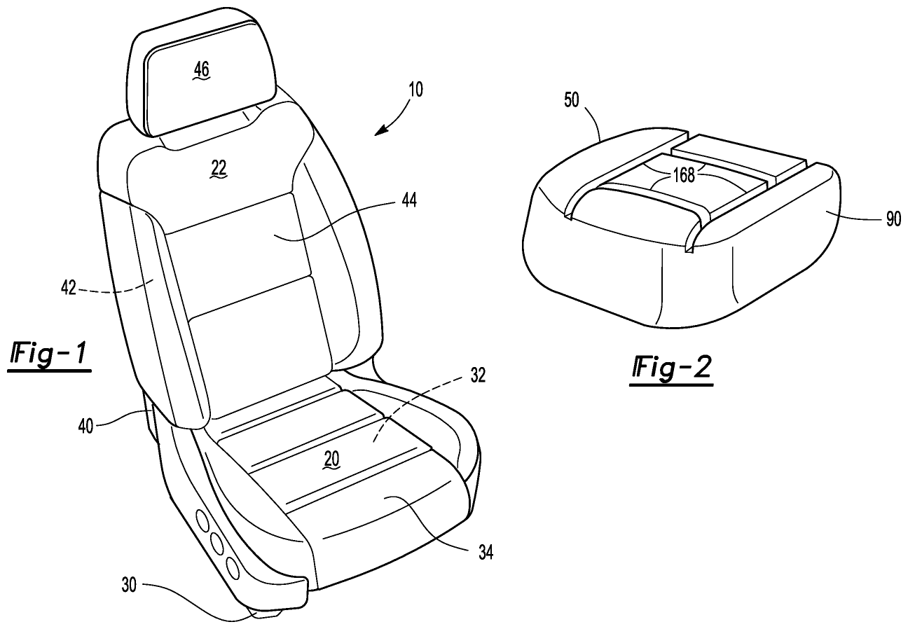

Referring to FIG. 1, an example of a seat assembly 10 is shown. In some embodiments, the seat assembly 10 is a vehicle seat assembly, such as for a land vehicle like a car, truck, bus, or the like, or for a non-land vehicle like aircraft or watercraft. For example, a seat assembly 10 for a land vehicle may be shaped and sized as a front row driver or passenger seat, a second, third, or other rear row seat, and may include bench-style seats as shown, bucket seats, or other seat styles. Furthermore, the seat assembly 10 may be a non-stowable seat or a stowable seat that may be foldable and stowable in a cavity in the vehicle floor. Additionally, the seat assembly 10 may be configured for non-vehicle applications such as furniture.

In the configuration shown in FIG. 1, the seat assembly 10 includes a seat bottom 20 and a seat back 22. It is contemplated that the seat back 22 may be omitted in some configurations, such as when the seat assembly 10 is configured as a motorcycle seat or stool.

The seat bottom 20 is configured to receive a seated occupant and support the pelvis and thighs of the seat occupant. The seat bottom 20 includes a seat bottom frame 30, a cushion 32, and a trim cover 34.

The seat bottom frame 30 is a structure that supports the cushion 32. The seat bottom frame 30 includes one or more structural members and may be made of any suitable material, such as a metal alloy, polymeric material, fiber reinforced polymeric material, or combinations thereof. In one or more configurations, the seat bottom frame 30 includes a panel, seat pan, suspension mat, or suspension wires upon which the cushion 32 is disposed.

The cushion 32 is disposed on the seat bottom frame 30. The cushion 32 is made of a compliant material that supports the seat occupant and distributes load forces from the seat occupant to the seat bottom frame 30. The cushion 32 and associated methods of manufacture will be discussed in more detail below.

The trim cover 34 covers at least a portion of the cushion 32. In addition, the trim cover 34 provides one or more visible exterior surfaces of the seat back 22. The seat occupant may be disposed on the trim cover 34 when seated upon the seat assembly 10. The trim cover 34 is made of any suitable material or materials, such as fabric, leather, leatherette, vinyl, or combinations thereof. The trim cover 34 may include a plurality of trim panels that are assembled in any suitable manner, such as by fusing or stitching. The trim cover 34 is attached to the seat bottom frame 30, the cushion 32, or both. For example, the trim cover 34 may include trim attachment features that are attached to the seat bottom frame 30, the cushion 32, or both, to inhibit removal of the trim cover 34 and help conform the trim cover 34 to the contour of the seat bottom frame 30, the cushion 32, or both.

The seat back 22 is configured to support the back of a seated occupant. The seat back 22 is disposed adjacent to the seat bottom 20. For example, the seat back 22 may be disposed above the seat bottom 20 and near the rear side of the seat bottom 20. The seat back 22 extends in a generally upward direction away from the seat bottom 20. In some configurations, the seat back 22 is mounted to the seat bottom 20 and may be pivotable with respect to the seat bottom 20. In other configurations, the seat back 22 is not mounted to the seat bottom 20. For instance, a vehicle seat back may be mounted to the vehicle body structure, such as in some second row seat assemblies. The seat back 22 includes a seat back frame 40, a cushion 42, a trim cover 44, and optionally a head restraint 46.

The seat back frame 40 is a structure that supports the cushion 42. The seat back frame 40 includes one or more structural members and may be made of any suitable material, such as a metal alloy, polymeric material, fiber reinforced polymeric material, or combinations thereof. In one or more configurations, the seat back frame 40 includes a panel, pan, suspension mat, or suspension wires upon which the cushion 42 is disposed. It is also contemplated that the seat back frame 40 may be integrally formed with the seat bottom frame 30.

The cushion 42 is disposed on the seat back frame 40. The cushion 42 is made of a compliant material that supports the seat occupant and distributes load forces from the seat occupant to the seat back frame 40. It is contemplated that the cushion 42 may be integrally formed with the cushion 32 of the seat bottom 20 or separate from the cushion 32 of the seat bottom 20. The cushion 42 and associated methods of manufacture will be discussed in more detail below.

The trim cover 44 covers at least a portion of the cushion 42. In addition, the trim cover 44 provides one or more visible exterior surfaces of the seat back 22. The seat occupant may be disposed on the trim cover 44 when seated upon the seat assembly 10. The trim cover 44 is made of any suitable material or materials, such as fabric, leather, leatherette, vinyl, or combinations thereof. The trim cover 44 may include a plurality of trim panels that are assembled in any suitable manner, such as by fusing or stitching. The trim cover 44 is attached to the seat back frame 40, the cushion 42, or both. For example, the trim cover 44 may include trim attachment features that are attached to the seat back frame 40, the cushion 42, or both, to inhibit removal of the trim cover 44 and help conform the trim cover 44 to the contour of the seat back frame 40, the cushion 42, or both.

The head restraint 46, if provided, is configured to support the head of a seat occupant. The head restraint 46 is disposed at the top of the seat back 22 or at an end of the seat back 22 that is disposed opposite the seat bottom 20. The head restraint 46 may be moveable in one or more directions with respect to the seat back 22 or may be integrally formed with the seat back 22.

Referring to FIG. 2, an example of a cushion 50 is shown. The cushion in generically designated with reference number 50 for convenience in reference. It is to be understood that the structure and description of the cushion 50 is applicable to cushion 32 of the seat bottom 20, cushion 42 of the seat back 22, or both.

The cushion 50 is a non-foam component or includes at least one non-foam component. The non-foam component is primarily referred to as a filament mesh structure but may also be referred to as a stranded mesh, mesh cushion, mesh structure, or mesh member. In FIG. 2, the cushion 50 is depicted as a non-foam component that does not include a foam component or foam material, such as urethane or polyurethane foam; however, it is contemplated that the cushion 50 may also include a foam component or foam material in addition to a non-foam component to provide additional cushioning or localized cushioning for a seat occupant. For example, foam material may be provided between the cushion 50 and a trim cover (e.g., trim cover 34, 44) that is disposed on the cushion 50, within the cushion 50, or combinations thereof. Reducing the amount of foam material that is provided with the cushion 50 or eliminating from material from the cushion 50 reduces weight and may improve support and comfort of a seat occupant.

The cushion 50 is primarily described below in the context of a cushion 50 that is a non-foam component that does not include foam material. In this context, the cushion 50 is made of filaments 52 of polymeric material that are randomly bent, curled, or looped and are bonded together as will be discussed in more detail below.

The filaments 52, which may also be referred to as strands or threads, are made of any suitable material or materials. In some configurations, the filaments 52 are made of a thermoplastic material or thermoplastic material, such as a thermoplastic resin that is polyamide-based, polyester-based, polyimide-based, polyolefin-based, polypropylene-based, polystyrene-based, or combinations thereof. As one example, a polyethylene-based filament may be made of linear low density polyethylene (LLPDE). The filament material may be recyclable unlike foam material or more easily recycled than foam material. It is also contemplated that a filament 52 may include reinforcement fibers and that the reinforcement fibers may not be made of a thermoplastic material.

The filament 52 may be a monofilament that is made of a single material or a filament 52 that is made of multiple materials. As an example, a filament 52 made of multiple materials may include a core that is made of a first thermoplastic material and a sheath that encircles the core and is made of a second thermoplastic material that differs from the first thermoplastic material. It is contemplated that the cushion 50 may include a combination of monofilaments and filaments that are made of multiple materials and are not monofilaments.

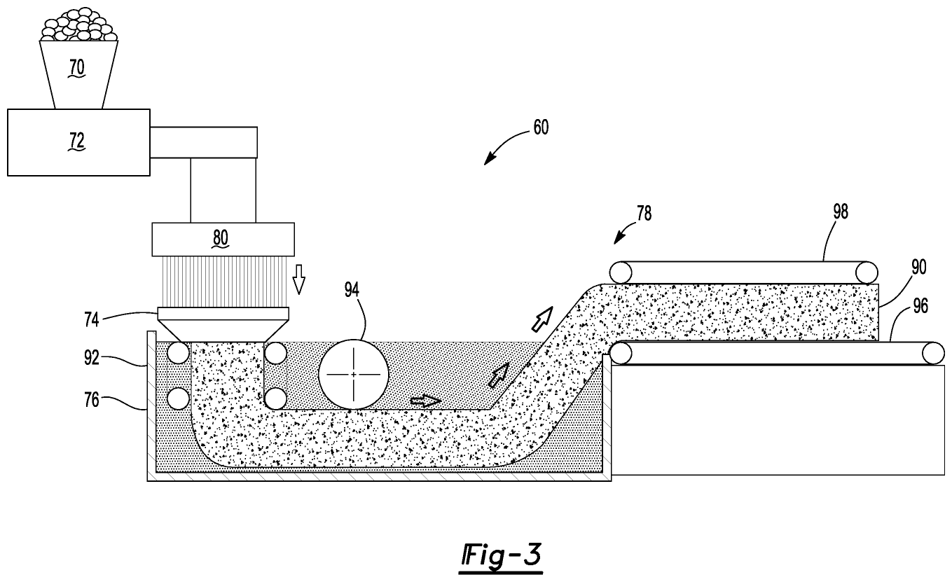

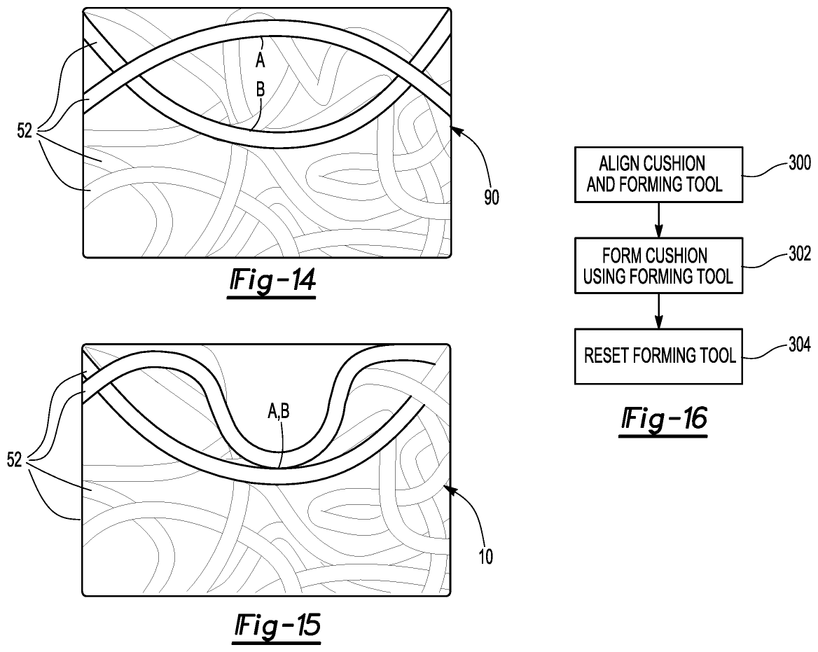

The filaments 52 are randomly bent, looped, curled, or entangled and may be bonded together where one filament 52 contacts another filament 52, thereby resulting in a lightweight, air permeable cushion (e.g., cushion 32 and/or 42) or mesh structure having openings or voids between the filaments 52. A magnified view of an example of filaments 52 in a mesh structure is shown in FIG. 14. An example of a method of making a mesh cushion or mesh structure is disclosed in U.S. patent application Ser. No. 17/555,875, which is hereby incorporated by reference in its entirety. An example of a manufacturing system 60 of making a cushion or filament mesh structure is also shown in FIG. 3. In this example, the manufacturing system 60 includes a hopper 70, an extruder 72, a funnel 74, a tank 76, and a material handling subsystem 78.

Referring to FIG. 3, a container or hopper 70 holds material stock that is to be extruded, such as solid beads, flakes, granules, pellets, or powder made of the material. The hopper 70 provides material stock to the extruder 72.

The extruder 72 melts the material stock and extrudes the material stock into filaments 52. The extruder 72 may have any suitable configuration. In some configurations, the extruder 72 includes a barrel that receives a rotatable screw and heating elements. Rotation of the screw forces the material to move through the barrel and helps heat the material due to the friction generated as the screw rotates. The material exits the barrel under pressure and in a molten state and is transported to a die 80 of the extruder 72.

The die 80, which may also be referred to as a die plate or extrusion die, has multiple through holes or filament forming openings through which the molten material passes. A single filament 52 is extruded from each through hole. The filaments 52 fall downward from the die 80 under the force of gravity into the funnel 74.

The funnel 74 consolidates or groups the filaments 52 into a more compact arrangement in which the filaments 52 bend, curl, or loop and each filament 52 contacts and bonds to at least one other filament 52. The funnel 74 has a funnel inlet and a funnel outlet that is smaller than the funnel inlet. Individual separated filaments 52 enter the funnel inlet. The filaments 52 bend, curl, or loop and move into contact as they accumulate. The filaments 52 slide down the funnel 74 toward the funnel outlet. Bonds are formed between filaments 52 at the points of contact while openings or voids between filaments 52 are present at other locations where one filament 52 does not contact or bond to another filament 52. The entangled and bonded filaments 52 pass through the funnel outlet of the funnel 74 and enter the tank 76. For convenience in reference, the bonded filaments 52 are referred to as a filament mesh structure 90.

The tank 76 holds a liquid, such as water or a mixture of water and another fluid. The liquid in the tank 76 helps support the entangled and bonded filaments 52 to limit further compacting or consolidation of the filaments 52 into a less open or less porous arrangement and maintains a desired porosity and density of the filament mesh structure 90. Thus, the liquid provides some buoyancy or resistance that can result in additional bending, curling, or looping of the filaments 52 adjacent to the surface of the liquid to further build the filament mesh structure 90. The liquid also cools the filaments 52 when the filaments 52 are in the liquid. For instance, the liquid cools the filaments 52 from the outside to solidify the filaments 52 and prevent the filaments 52 from bonding at additional locations. At this point, the filaments 52 are relatively stiff and no longer in a plastic state and thus generally maintain a shape and are not moldable or reformable without being heated.

The material handling subsystem 78 transports the filament mesh structure 90 through the tank 76. the material handling subsystem 78 includes various rollers and conveyors that help move the filament mesh structure 90 through the liquid and out of the liquid. In some configurations, a tractor conveyor 92 is provided in the tank 76 to help pull the filament mesh structure 90 away from the funnel 74 and to counter buoyancy of the filaments 52.

Other rollers, such as roller 94, keep the filament mesh structure 90 submerged in the liquid and guide the filament mesh structure through the tank 76. For example, the roller 94 may guide the filament mesh structure 90 toward a conveyor belt 96 and shaker table 98 that are disposed outside of the tank 76. The shaker table 98 shakes the filament mesh structure 90 while it is on the conveyor belt 96 to remove liquid. Alternatively or in addition, the filament mesh structure 90 may be squeezed to remove liquid, pressurized air may be blown toward the filament mesh structure 90 to remove liquid, or both.

The manufacturing system 60 described above is a continuous flow process in which the filament mesh structure 90 is formed as a continuous structure when filament extrusion is not interrupted. Further processing of the filament mesh structure 90 is provided after exiting the tank 76 to cut the filament mesh structure 90 into individual pieces for individual cushions and to provide a cushion 50 having a desired size and shape. For example, the cross sectional shape of the filament mesh structure 90 may correspond with the shape of the funnel outlet. A manufacturing system 60 that has a funnel outlet with a rectangular opening produces a filament mesh structure 90 that has a generally rectangular shape or rectangular cross section. If a cushion 50 is desired with a different shape or different cross section, then additional contouring or shaping steps are performed. For instance, the filament mesh structure 90 may be cut to remove material to shape or contour an exterior side, to provide a through hole, blind hole, notch, groove, trench, or slit, or combinations thereof. Cutting, contouring, and shaping of the mesh material can be accomplished using a cutting system 100.

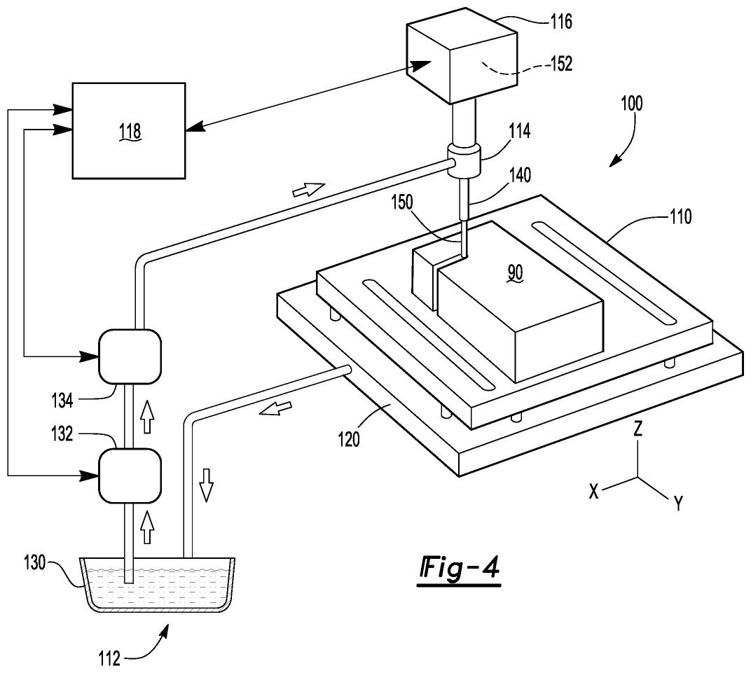

Referring to FIG. 4, an example of a cutting system 100 is shown. The cutting system 100 is a fluid-based cutting system that provides a pressurized fluid to cut one or more filaments 52 of the filament mesh structure 90. Thus, the fluid is a cutting medium. The fluid is primarily described below as being a liquid, such as liquid water a fluid that includes liquid water; however, it is contemplated that the fluid could be a gas, and that an abrasive material may be added to the fluid as a cutting medium. In some configurations, the cutting system 100 includes platform 110, a fluid supply subsystem 112, a cutting head 114, an automation 116, and a controller 118. The cutting system 100 may have additional fluid system components, such as filters, accumulators, vents, and the like that are not shown for simplicity.

The platform 110 supports the filament mesh structure 90. In some configurations, the platform 110 is configured as a table or workstation that supports the filament mesh structure 90 in a stationary position. In other configurations, the platform 110 is a conveyor that supports the filament mesh structure 90 and is configured to move the filament mesh structure 90. The platform 110 may include a catchment device 120 that collects or receives fluid, such as a liquid that is expelled or sprayed by the cutting head 114. For example, the catchment device 120 may be configured as a pan or tray that is provided with the platform 110 or is positioned under the platform 110. The catchment device 120 may be fluidly connected to the fluid supply subsystem 112, such as when the fluid is a liquid.

The fluid supply subsystem 112 provides fluid to the cutting head 114. The fluid supply subsystem 112 includes a fluid source 130, a pump 132, and one or more fluid regulating devices 134

The fluid source 130 contains or supplies the fluid. The fluid source 130 may be pressurized or unpressurized. Examples of a pressurized fluid source include a pressurized tank, a pressurized supply line, or the like. An example of an unpressurized fluid source is an open tank or reservoir. In some configurations, the fluid source 130 receives fluid from the catchment device 120 to permit the fluid to be recycled or reused.

The pump 132 is fluidly connected or fluidly connectable to the fluid source 130 and the cutting head 114. The pump 132 increases the pressure of the fluid to facilitate delivery of the fluid to the cutting head 114.

One or more fluid regulators or fluid regulating devices 134, such as valves, are provided to control flow of the fluid, such as the flow of fluid from the fluid source 130 to the cutting head 114.

The pump 132 and fluid regulating devices 134 may be controlled as described below to control the flow of fluid to the cutting head 114, such as to permit or start fluid flow, stop fluid flow, control the fluid pressure, and control the fluid flow rate.

The cutting head 114 contains a nozzle 140 that provides a jet or stream of fluid. The jet or stream of fluid is configured to cut a filament 52 when directed against a filament 52 at a sufficient pressure. The jet of stream of fluid may extend along an axis from the outlet or exit orifice of the nozzle 140. The nozzle 140 is in fluid communication or fluidly connected to the fluid supply subsystem 112 via a conduit, such as a hose or pipe. The cutting head 114 is mounted to the automation 116.

The automation 116 is configured to position the cutting head 114. In some configurations, the automation 116 is a robotic arm, robotic manipulator, or linear actuator. The automation 116 may be a one-axis automation, two-axis automation, three-axis automation, or have more than three axes to provide greater degrees of freedom for the automation movement. For instance, automation 116 may have up to six degrees of freedom, and may have freedom of movement in one or more of the following (including any combination thereof): in translation in the X, Y, and Z (horizontal, vertical, and depth) directions, and in rotation with pitch, yaw and roll.

The automation 116 can hold the cutting head 114 in a stationary position or move the cutting head 114 with respect to the filament mesh structure 90 to facilitate cutting of the filament mesh structure 90. In one example, the automation 116 may include one or more actuators 150 that are configured to move the cutting head 114. For instance, an actuator 150 may be configured to move the cutting head 114 along a linear path, such as when the automation 116 moves in translation along an axis or in a plane, such as the XZ plane shown in FIG. 4. In other examples, the automation 116 may include one or more actuators 150 that are configured move or cooperate to move the cutting head 114 in a complex path across the filament mesh structure 90, such as in a path that includes changes in direction nonlinear paths, linear paths, or a combination thereof with movement in the XY plane, and/or move the cutting head 114 toward or away from the filament mesh structure 90 in a vertical direction or in the YZ plane for an automation with more than one degree of freedom.

Furthermore, the automation 116 may include additional actuators 150 that control the angle of the cutting head 114 relative to the filament mesh structure 90 and allow for rotation or tilt of the cutting head 114 with respect to the X, Y, and Z axes or planes. Rotation or tilt of the cutting head 114 allows for angled cuts relative to the XY, YZ, and XZ planes, such as chamfers, angled slits, or V-shaped trenches.

In some configurations, the automation 116 includes at least one support member that is fixed and extends across the filament mesh structure 90 and supports one or more actuators 150 and the cutting head 114 for movement relative thereto, such as by sliding the cutting head 114 in translation across or along the support member.

The controller 118 monitors and controls operation of the cutting system 100. The controller 118 includes one or more controllers or control modules, which may be distributed or centralized. Some or all of the controllers may be connected by a controller area network (CAN) or other system. The controller 118 communicates with various components of the cutting system, such as the platform 110 (when configured as a conveyor), the fluid supply subsystem 112 (e.g., the pump 132 and fluid regulating devices 134), and the automation 116.

The controller 118 receives inputs or input signals from sensors that are provided with the cutting system 100, such as proximity sensors, speed sensors, pressure sensors, flow rate sensors, and the like for use in controlling the cutting system 100. Furthermore, the controller 118 may receive inputs from other systems in the manufacturing process or from a user. In one example, the controller 118 receives an input indicative of a density of the filament mesh structure 90.

The controller 118 is configured to control the velocity of the platform 110 that is configured as a conveyor, including stopping, starting, and changing the direction of travel. As an example, the velocity of the conveyor may be stopped or reduced when a cut is being made.

The controller 118 is configured to control movement of the automation 116 by controlling its actuators 150, and thus control the position, orientation, and speed of movement or travel speed of the cutting head 114 and nozzle 140 relative to the filament mesh structure 90.

The controller 118 is configured to control the fluid flow from the nozzle 140, such as by controlling the pump 132 and fluid regulating devices 134, to permit fluid flow to the nozzle 140, increase fluid flow to the nozzle 140, decrease fluid flow to the nozzle 140, and stop fluid flow to the nozzle 140. The controller 118 is configured to increase, decrease, or maintain the fluid pressure provided to the nozzle 140, the fluid flow rate at the nozzle 140, or both.

It is recognized that the controller 118 or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which cooperate or co-act with one another to perform operation(s) disclosed herein. In addition, any one or more of the electrical devices as disclosed herein may be configured to execute a computer-program that is embodied in a non-transitory computer readable medium that is programmed to perform any number of the functions as disclosed herein.

The controller 118 is configured to control the speed of the cutting head 114 as well as the pressure and flow rate of the fluid exiting the nozzle 140 depending on the thickness of the filament mesh structure 90 and the selected depth of the cut into the filament mesh structure 90. Furthermore, the controller 118 may control the cutting head 114 and cutting system 100 to provide a single pass cut or to provide a multi-pass cut where the selected cut requires multiple passes of the cutting head 114 along the cutting path.

The cutting system 100 may provide for a planar cut, or a cut along a single plane that is aligned with or angled relative to the X, Y, and/or Z planes. A planar cut may result in a planar side or planar surface of the filament mesh structure 90. Furthermore, the cutting system 100 may provide a cut along a single axis.

The cutting system 100 may provide a cut entirely through the filament mesh structure 90 to separate the filament mesh structure into separate pieces, either with a single pass of the cutting head 114 relative to the filament mesh structure 90, or with more than one pass of the cutting head 114.

Furthermore, the cutting system 100 is controllable in a manner that provides a variable depth of cut. The presence and location of the filaments 52 varies in the filament mesh structure 90 since the filaments 52 are bent, looped, or otherwise shaped in various directions with voids therebetween. The cutting system 100 is therefore controllable to adjust the fluid jet depending on the presence, quantity, size, or absence of filaments 52 at a location where a cut is to be provided in the filament mesh structure 90. For example, the cutting system 100 is controllable to increase the force exerted by the fluid jet when cutting through multiple filaments, when cutting through larger diameter filaments, or to reach and cut a filament located a greater depth or distance from the nozzle 140. For cuts like partial cuts that do not extend completely through the filament mesh structure 90, the cutting system 100 may be operated with an additional pass of the cutting head 114 at a lower speed, lower fluid pressure, and/or lower fluid flow rate to increase the precision and/or accuracy of the cut into the filament mesh structure 90.

The cutting system 100 is configured to provide multiple types of cuts in the filament mesh structure 90. These include a through cuts and partial cuts or “blind cuts” in the filament mesh structure 90. A through cut can separate the filament mesh structure 90 into separate pieces or provide a through hole or slit that does not result in separate pieces. A partial cut does not extend completely through the filament mesh structure 90 and may be used to provide a blind hole, trench, slit, or slot. According to various examples, the cutting system 100 may be controlled to provide an orthogonal cut, a bevel, a fillet, a radius, or the like.

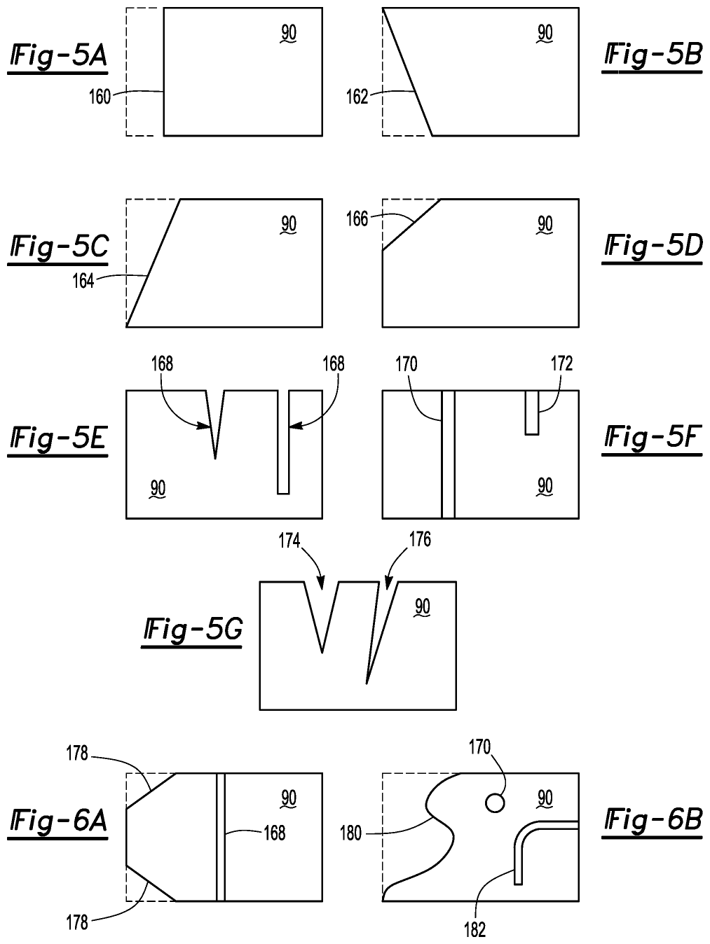

FIGS. 5A-5G illustrate views that can be either side views or section views of a filament mesh structure (e.g., filament mesh structure 90) with some examples of various cuts that can be provided by the cutting system 100. These examples are not exhaustive. In these figures, the filament mesh structure 90 is represented as being a rectangular block prior to cutting. Dashed lines are used to represent areas of the rectangular block that are cut away.

FIG. 5A illustrates an orthogonal cut 160, which may produce an orthogonal side or orthogonal surface. FIG. 5B illustrates an undercut fillet 162. FIG. 5C illustrates a fillet 164. FIG. 5D illustrates a chamfer 166. FIG. 5E illustrates two partial cuts to different cut depths to form two trenches 168 and may be either a side view or a section view. FIG. 5F illustrates a through slot or through hole 170 and a blind hole 172 as a section view. FIG. 5G illustrates a V-shaped channel 174, which may also be referred to as a channel, recess, or slit, and an angled partial cut 176 and may be either a side view or a section view. The V-shaped channel 174 could also be provided with a greater depth and extend through the filament mesh structure 90. A V-shaped channel 174 or angled partial cut 176 is provide by executing two cuts, such as blind cuts, along different cutting paths that are angled relative to one another and intersect.

FIGS. 6A and 6B illustrate top views of a filament mesh structure (e.g., filament mesh structure 90) with various cuts that can be provided with the cutting system 100. These examples are not exhaustive. FIG. 6A illustrates a double chamfer 178 and a trench 168 cut to a partial depth and extending transversely across the filament mesh structure 90. FIG. 6B illustrates an example of a curved cut or curved contour 180, which may include a curved side having a convex section, concave section, or combinations thereof. FIG. 6B also shows an example of a through hole 170, and a trench 182 that has two angled sections connected by an arcuate portion and extends only partially across the filament mesh structure 90 and is either a through cut or a partial cut.

It is to be understood that the cutting system 100 can provide cuts along various sides of the filament mesh structure 90. Moreover, the cutting system 100 can provide through cuts and partial cuts along linear and nonlinear paths and in three dimensions. For instance, the cutting system 100 can provide curved or contour surfaces when viewed along multiple axes, such as any combination of the X, Y, and Z axes.

The controller 118 is configured to control movement of the automation 116 and the fluid flow and fluid pressure provided by the fluid supply subsystem 112 to the nozzle 140 in unison to provide a cut of a desired type at a desired location. In some instances, a deeper cut may be provided by controlling the automation 116 to move the cutting head 114 at a slower speed, by controlling the automation 116 to move the nozzle 140 closer to the filament mesh structure 90, by controlling the automation 116 to move the nozzle 140 along multiple or repeated cutting passes, by increasing the fluid flow to the nozzle 140, by increasing the fluid flow rate to the nozzle 140, or combinations thereof. Similarly, a shallower cut may be provided by controlling the automation 116 to move the cutting head 114 at a higher speed, by controlling the automation 116 to move the nozzle 140 further from the filament mesh structure 90, by controlling the automation 116 to move the nozzle 140 along fewer cutting passes or not repeating cutting passes, by decreasing the fluid flow to the nozzle 140, by decreasing the fluid flow rate to the nozzle 140, or combinations thereof.

The control parameters associated with a particular type of cut may be based on experimentation or modeling. For instance, a filament mesh structure 90 may be made with the manufacturing system 60. Associated filament parameters are recorded, such as the number of filaments extruded through the die 80, the filament size (e.g., cross sectional area), and filament extrusion speed. Then, the density of the resultant filament mesh structure 90 is measured, such as by hydrostatic weighing, and recorded. Then, sample cuts may be performed with the cutting system 100 at various cutting head speeds, fluid pressures, fluid flow rates to determine combinations of speeds, pressures, and flow rates are sufficient to provide a desired cut in the filament mesh structure 90. Acceptable ranges or combinations of speeds, pressures, and flow rates may be recorded or stored in memory and may be associated with the density of the filament mesh structure 90 since the density was previously measured. The acceptable ranges or combinations are then input to or used by the controller 118 to control the cutting system 100 based on the density of the filament mesh structure 90.

As a non-limiting example, the nozzle 140 is provided with a diameter of eight thousandths of an inch, and is operated at a distance of five to ten millimeters from the filament mesh structure 90. The fluid jet is provided at a pressure within the range of 58000-70000 psi (399895-482633 kPa), and the nozzle has a speed relative to the filament mesh structure 90 within a range of 1-75 mm/s. The fluid jet provided a through cut in a filament mesh structure 90 with a density within the range of 2.7-3.4 pounds per cubic feet (43.2-54.5 kg/m³) with a filament diameter of 0.5 mm. In other examples, each of the nozzle diameter, the distance, the speed of the nozzle, the pressure, and/or the filament mesh structure 90 density or filament diameter may be greater or less than the stated range or value.

It is contemplated that multiple cutting systems 100, such as cutting systems arranged in parallel or series, can be used to increase throughput. It is also contemplated that the filament mesh structure 90 may be cut using other cutting techniques, such as a mechanical cutter like a cutting wheel, in combination with the making cuts with the cutting system 100.

A method associated with cutting system 100 is used to form a cushion (e.g., cushion 32 and/or 42), and further is optionally used to assemble a seat (e.g., seat assembly 10). In various examples, the method may have greater or fewer steps than described below, and various steps may be performed in another order, sequentially, or simultaneously.

The method includes cutting a filament mesh structure (e.g., filament mesh structure 90) with a fluid jet (e.g., fluid jet 150).

In some embodiments, cutting the filament mesh structure (e.g., filament mesh structure 90) with the fluid jet (e.g., fluid jet 150) at least partially forms a cushion (e.g., cushion 32 and/or 42).

In some embodiments, the method includes attaching the cushion (e.g., cushion 32 and/or 42), to a frame (e.g., frame 30 and/or 40), of a seat assembly (e.g., seat assembly 10).

In some embodiments, the method includes positioning a trim cover (e.g., trim cover 34 and/or 44) over the cushion (e.g., cushion 32 and/or 42) and attaching the trim cover (e.g., trim cover 34 and/or 44) to the cushion (e.g., cushion 32 and/or 42), to the frame (e.g., frame 30 and/or 40), or to the cushion (e.g., cushion 32 and/or 42) and the frame (e.g., frame 30 and/or 40).

In some embodiments, the method includes forming the filament mesh structure (e.g., filament mesh structure 90) with filaments (e.g., filaments 52) of thermoplastic material, the filaments (e.g., filaments 52) being randomly looped and bonded.

In some embodiments, forming the filament mesh structure (e.g., filament mesh structure 90) includes extruding the thermoplastic material through a die (e.g., die 80) to form the filaments (e.g., filaments 52) and then passing the filaments (e.g., filaments 52) through a funnel (e.g., funnel 74).

In some embodiments, the method includes cutting the filament mesh structure (e.g., filament mesh structure 90) after the filaments (e.g., filaments 52) pass through the funnel (e.g., funnel 74).

In some embodiments, the method includes comprising controlling a travel speed of a cutting head (e.g., cutting head 114) to control a depth of a cut (e.g., orthogonal cut 160, undercut fillet 162, fillet 164, chamfer 166, trench 168, through hole 170, blind hole 172, V-shaped channel 174, partial cut 176, chamfer 178, curved contour 180, trench 182) into the filament mesh structure (e.g., filament mesh structure 90).

In some embodiments, the method includes decreasing the travel speed of the cutting head (e.g., cutting head 114) to increase the depth of the cut (e.g., orthogonal cut 160, undercut fillet 162, fillet 164, chamfer 166, trench 168, through hole 170, blind hole 172, V-shaped channel 174, partial cut 176, chamfer 178, curved contour 180, trench 182) into the filament mesh structure (e.g., filament mesh structure 90).

In some embodiments, the method includes moving the cutting head (e.g., cutting head 114) closer to the filament mesh structure (e.g., filament mesh structure 90) to increase the depth of the cut (e.g., orthogonal cut 160, undercut fillet 162, fillet 164, chamfer 166, trench 168, through hole 170, blind hole 172, V-shaped channel 174, partial cut 176, chamfer 178, curved contour 180, trench 182) into the filament mesh structure (e.g., filament mesh structure 90).

In some embodiments, the method includes increasing a fluid pressure provided to the cutting head (e.g., cutting head 114) to increase the depth of the cut (e.g., orthogonal cut 160, undercut fillet 162, fillet 164, chamfer 166, trench 168, through hole 170, blind hole 172, V-shaped channel 174, partial cut 176, chamfer 178, curved contour 180, trench 182) into the filament mesh structure (e.g., filament mesh structure 90).

In some embodiments, the method includes increasing a fluid flow rate of the fluid jet (e.g., fluid jet 150) to increase the depth of the cut (e.g., orthogonal cut 160, undercut fillet 162, fillet 164, chamfer 166, trench 168, through hole 170, blind hole 172, V-shaped channel 174, partial cut 176, chamfer 178, curved contour 180, trench 182) into the filament mesh structure (e.g., filament mesh structure 90).

In some embodiments, cutting the filament mesh structure (e.g., filament mesh structure 90) with the fluid jet (e.g., fluid jet 150) includes positioning the cutting head (e.g., cutting head 114) remotely from the filament mesh structure (e.g., filament mesh structure 90) such that the cutting head (e.g., cutting head 114) does not contact the filament mesh structure (e.g., filament mesh structure 90).

In some embodiments, the method includes controlling an automation (e.g., automation 116) supporting the cutting head (e.g., cutting head 114) to move the cutting head (e.g., cutting head 114) along a cutting path relative to the filament mesh structure (e.g., filament mesh structure 90).

In some embodiments, the method includes controlling the automation (e.g., automation 116) in at least one degree of freedom to move the cutting head (e.g., cutting head 114) along the cutting path.

In some embodiments, the method includes controlling the automation (e.g., automation 116) in at least three degrees of freedom to move the cutting head (e.g., cutting head 114) along the cutting path.

In some embodiments, the method includes cutting entirely through the filament mesh structure (e.g., filament mesh structure 90) via the fluid jet (e.g., fluid jet 150).

In some embodiments, the method includes cutting partially through the filament mesh structure (e.g., filament mesh structure 90) via the fluid jet (e.g., fluid jet 150).

In some embodiments, the method includes cutting one or more of a planar surface and a curved contour (e.g., curved contour 180) in the filament mesh structure (e.g., filament mesh structure 90) via the fluid jet (e.g., fluid jet 150).

In some embodiments, the method includes cutting one or more of an orthogonal surface (e.g., orthogonal cut 160), a fillet (e.g., undercut fillet 162, fillet 164), a chamfer (e.g., chamfer 166), and a trench (e.g., trench 168) in the filament mesh structure (e.g., filament mesh structure 90) via the fluid jet (e.g., fluid jet 150).

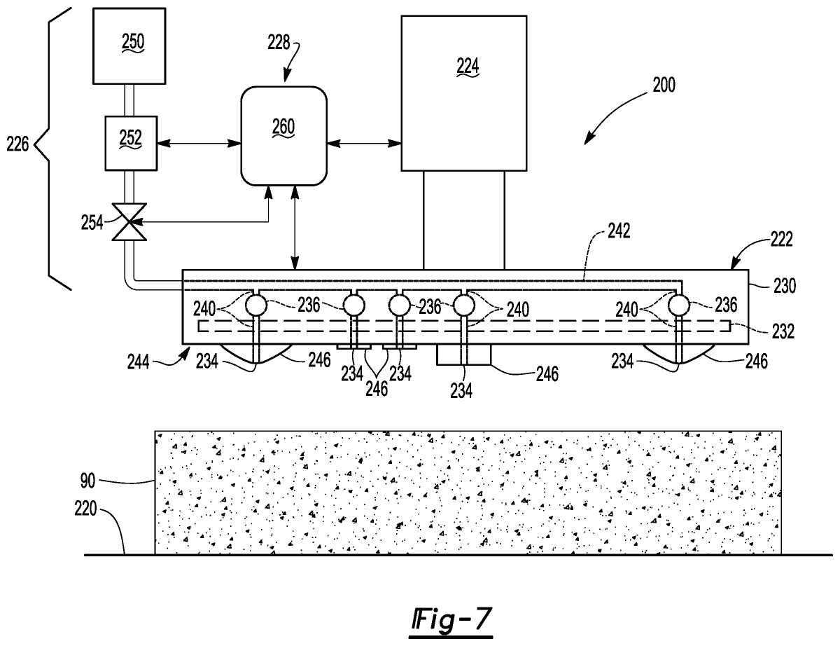

Referring to FIG. 7 an example of a forming system 200 for forming a filament mesh structure 90 is shown. The forming system 200 is configured to form or shape the filament mesh structure 90 without cutting or severing filaments 52 of the filament mesh structure 90. The filament mesh structure 90 can be formed or shaped with the forming system 200 alone or in combination with the cutting system 100 previously discussed.

As previously discussed, the manufacturing system 60 produces a filament mesh structure 90 having a particular cross-sectional shape, such as a rectangular cross-section. In some cases, the cross-sectional shape produced by the manufacturing system 60 does not provide a desired profile or seat cushion profile. Moreover, the filaments 52 of the filament mesh structure 90 that is output from the manufacturing system 60 are cooled and hardened such that the filaments 52 are relatively stiff and no longer in a plastic state and thus not moldable or formable. Thus, it may be desired to alter the shape of the filament mesh structure 90 from its original cross-sectional profile (e.g., the cross-sectional profile produced by the manufacturing system 60) to provide one or more indentations, protruding regions, curved regions, and the like. As an example, the filament mesh structure 90 or a portion thereof is heated and reformed or reshaped to provide one or more recesses 210, examples of which are shown in FIG. 10.

A recess 210 that is provided in the filament mesh structure 90 may be an elongated channel, hole, indentation, or trench. A recess 210 may be provided in any suitable location. For instance, a recess 210 may be provided in a side of the filament mesh structure 90 that is configured to face toward a seat occupant. As some additional examples, a recess 210 may be provided where a side bolster meets a center seating portion of the filament mesh structure 90, a recess 210 may extend across the center seating portion such as from front to back or side to side, or combinations thereof. Recesses 210 may be spaced apart from each other or may intersect. A recess 210 may extend partially into but not completely through the filament mesh structure 90.

Referring to FIG. 7, an example of the forming system 200 is shown. The forming system 200 includes a support surface 220, a forming tool 222, a positioning device 224, a steam subsystem 226, and a control system 228.

The support surface 220 is configured to support the filament mesh structure 90. The support surface 220 may be a generally flat surface as shown in FIG. 7. Alternatively, the support surface 220 may be contoured. The support surface 220 may be a stationary surface or a moveable surface. It is contemplated that the support surface 220 may be a portion of a forming die.

The forming tool 222 facilitates forming or shaping of the filament mesh structure 90. More specifically, the forming tool 222 is configured to reshape the filament mesh structure 90 to alter or change the shape or cross-section of the filament mesh structure 90 in one or more locations. The forming tool 222 is mounted to the positioning device 224.

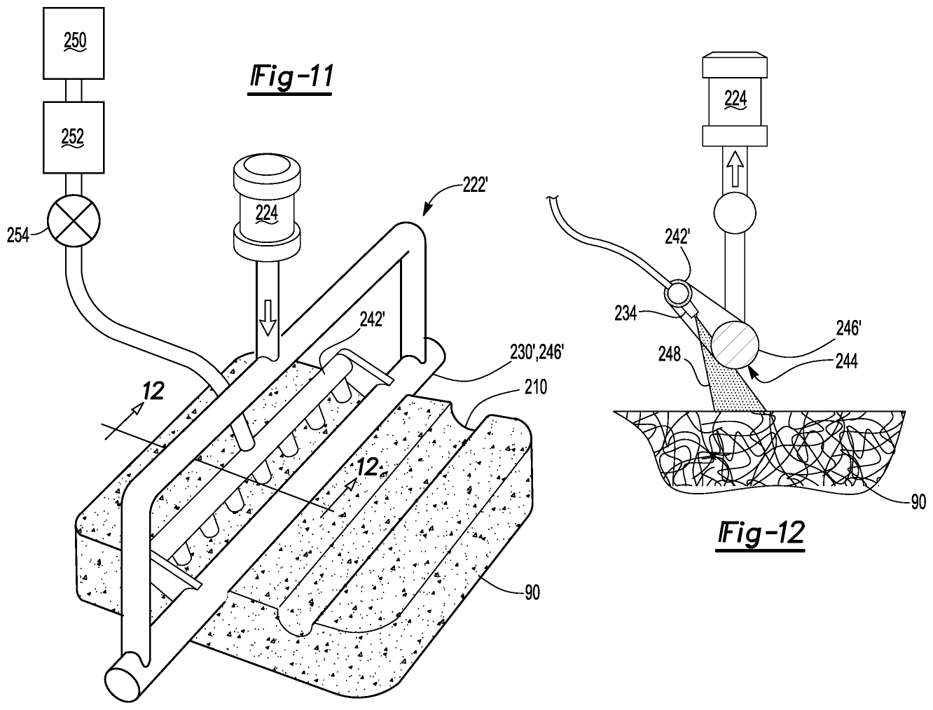

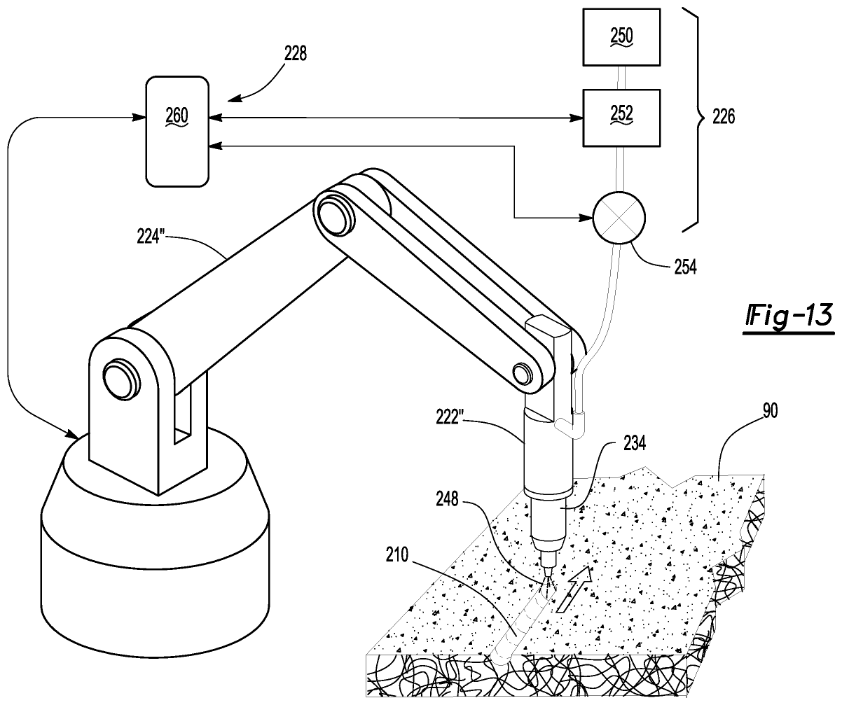

The forming tool 222 may be provided in various configurations. These configurations are broadly categorized by how the forming tool reshapes the filaments 52 of the filament mesh structure 90. For instance, a forming tool may reshape the filament mesh structure 90 by engaging the forming tool with the filament mesh structure 90, without engaging the forming tool with the filament mesh structure 90, or combinations thereof. In FIGS. 7-10 and FIGS. 11 and 12, examples of forming tools 222, 222′ are shown in which the forming tool engages and exerts force against at least some of the filaments 52 to reshape at least one filament 52 of the filament mesh structure 90. In the configuration shown in FIG. 13 the forming tool 222″ does not engage and exert force against filaments 52 to reshape the filament mesh structure 90. In each configuration, the forming tool 222, 222′, 222″ includes one or more nozzles that are fluidly connected to the steam subsystem 226.

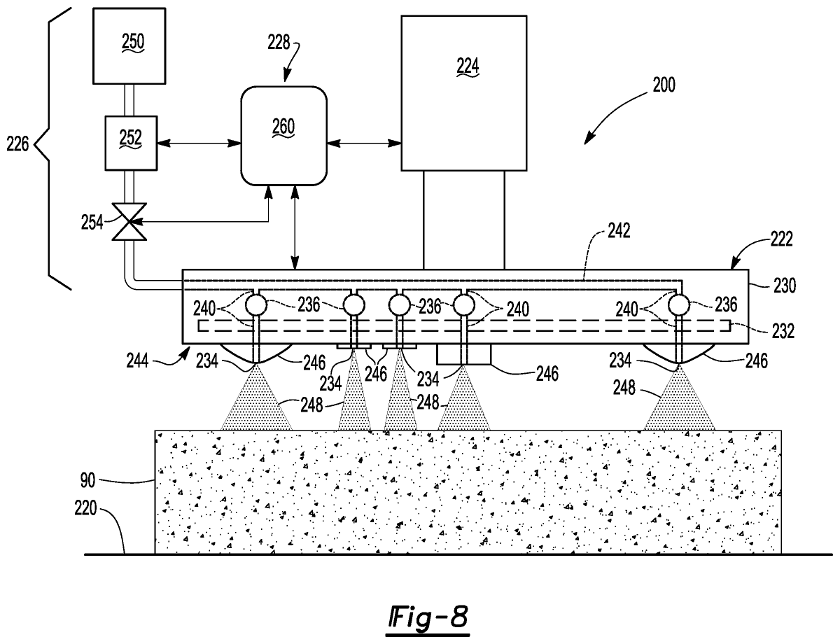

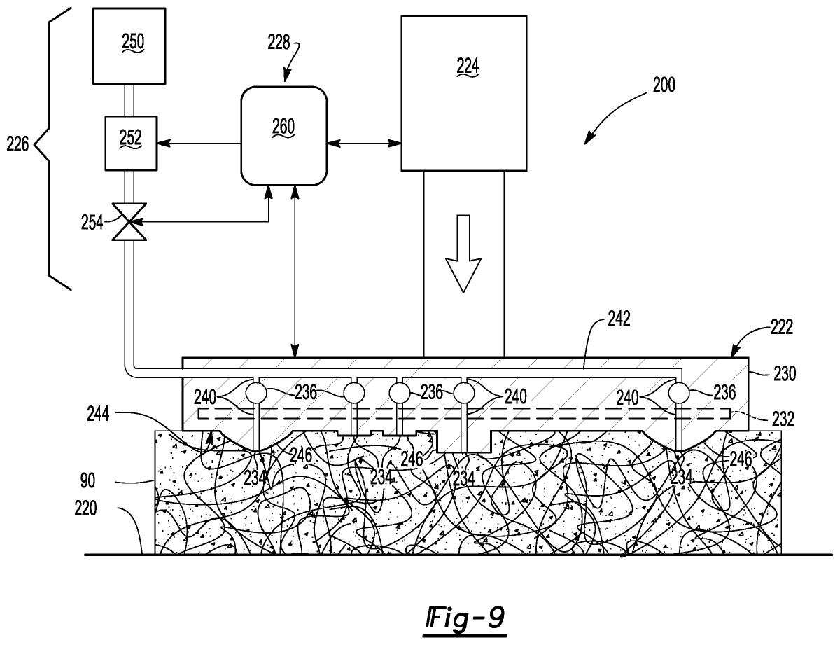

Referring to FIGS. 7-10, the forming tool 222 is illustrated as being positioned above the filament mesh structure 90 and the support surface 220. In FIGS. 7 and 8, the filament mesh structure 90 is illustrated with a speckled pattern to represent a non-sectioned view for clarity and simplicity. In FIGS. 9 and 10, filaments of the filament mesh structure 90 are pictorially represented by randomly drawn lines to represent a section view of the filament mesh structure 90 so that the recesses 210 are more clearly visible. The forming tool 222 includes a tool body 230, a heater 232, one or more nozzles 234, one or more nozzle valves 236, or combinations thereof.

The tool body 230 provides the main structure of the forming tool 222. The tool body 230 is mountable to the positioning device 224 and includes or defines one or more passages 240 that fluidly connect the steam subsystem 226 to the nozzles 234 and nozzle valves 236. For instance, the tool body 230 may include a manifold 242 from which the passages 240 may extend. The tool body 230 has a forming side 244.

The forming side 244 faces toward the filament mesh structure 90 and the support surface 220. In at least one configuration, the forming side 244 includes one or more forming features 246. A forming feature 246 is configured as a protrusion that extends toward the filament mesh structure 90, an indentation that extends away from the filament mesh structure 90, or combinations thereof. One or more nozzles 234 may be provided with a forming feature 246.

The heater 232, if provided, is configured to heat the forming side 244 of the forming tool 222. The heater 232 may have any suitable configuration. For instance, the heater 232 may be configured as an electrical or electrical resistance heater, circulate a heated fluid through the tool body 230, or the like. It is also contemplated that the heater 232 may be part of the steam subsystem 226. For instance, steam or a heated fluid such as water may be circulated in the tool body 230 before being routed to one or more nozzles 234. Heat or thermal energy that is provided to the forming side 244 by the heater 232 increases the temperature of a forming feature 246, which facilitates reforming or reshaping of the filaments 52 as will be discussed in more detail below.

One or more nozzles 234 are provided with the tool body 230. A nozzle 234 is fluidly connected to the steam subsystem 226 and directs pressurized steam 248 toward the filament mesh structure 90 to heat one or more filaments 52 of the filament mesh structure 90 to facilitate reforming or reshaping of the filaments 52 as will be discussed in more detail below. A nozzle 234 has at least one orifice through which steam 248 may be expelled. One or more nozzles 234 may be provided with a forming feature 246. In FIG. 7, the nozzles 234 are illustrated as being disposed generally perpendicular to a top side of the filament mesh structure 90 prior to reshaping; however, it is contemplated that a nozzle 234 may be disposed in a non-perpendicular relationship with the top side of the filament mesh structure 90 or that additional nozzles 234 or orifices may be provided that may be disposed in a non-perpendicular relationship with the top side.

A nozzle valve 236 controls flow to one or more associated nozzles 234. In the configuration shown in FIG. 7, each nozzle valve 236 is illustrated as being associated with a single nozzle 234; however, it is contemplated that a nozzle valve 236 may be associated with multiple nozzles 234 and that some or all of the nozzles 234 may not be fluidly connected to a nozzle valve 236. In some configurations, a nozzle valve 236 is provided with or within the tool body 230. A nozzle valve 236 is actuatable between an open position and a closed position. In the open position, a nozzle valve 236 permits flow from the steam subsystem 226 through the nozzle valve 236 and to one or more associated nozzles 234. In the closed position, a nozzle valve 236 prevents flow from the steam subsystem 226 through the nozzle valve 236 and to one or more associated nozzles 234.

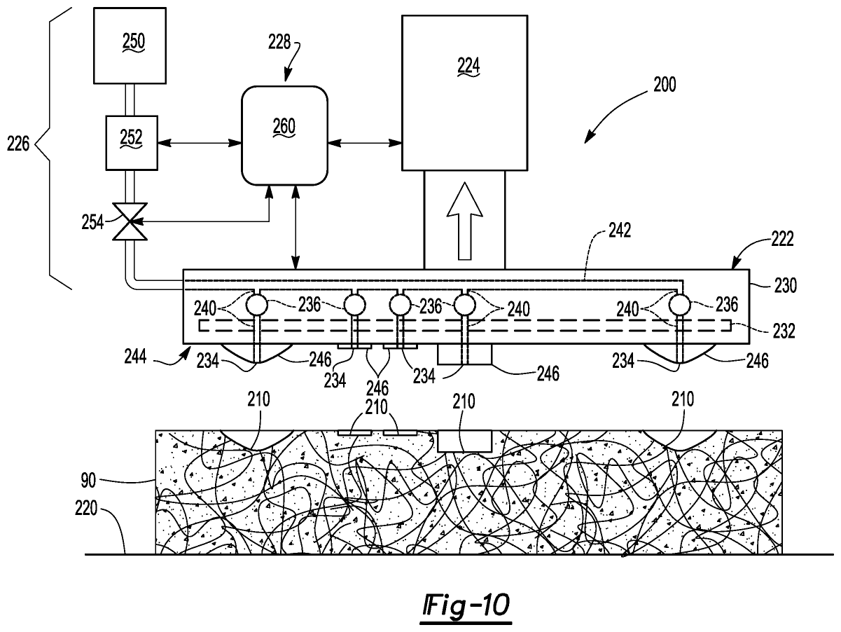

Referring to FIGS. 11 and 12, another example of a forming tool 222′ is shown. In FIG. 11, the filament mesh structure 90 is illustrated with a speckled pattern to represent a non-sectioned view for clarity and simplicity. In FIG. 12, filaments of the filament mesh structure 90 are pictorially represented by randomly drawn lines to represent a section view of the filament mesh structure. The forming tool 222′ is positionable above the filament mesh structure 90 and may include a tool body 230′, a manifold 242′, and one or more nozzles 234.

The tool body 230′ is fixedly positioned with respect to the manifold 242′, the nozzles 234, or both. In at least one configuration, the tool body 230′ is spaced apart from the nozzles 234 and does not contact the nozzles 234. The tool body 230′ is moved or actuated by the positioning device 224. The tool body 230′ is moved or actuated against and at least partially into the filament mesh structure 90 to exert pressure that reshapes one or more filaments 52 as will be discussed in more detail below. The tool body 230′ may be configured as a wire, rod, or tube that may extend completely across or partially across the top side of the filament mesh structure 90.

The manifold 242′ fluidly connects the steam subsystem 226 to the nozzles 234. For instance, the manifold 242′ may be configured as a tube or pipe that distributes fluid to the nozzles 234. In addition, the manifold 242′ may be positioned further from the top side of the filament mesh structure 90 than at least a portion of the tool body 230′ so that the manifold 242′ and/or one or more nozzles 234 do not contact or engage the filaments 52 during reshaping.

One or more nozzles 234 are fluidly connected to the manifold 242′. One or more nozzle valves 236 may optionally be provided to control fluid flow to one or more nozzles 234 as previously discussed. The nozzles 234 may be spaced apart from each other and are arranged to provide steam 248 that heats the filaments 52 and the tool body 230′.

Referring to FIG. 13, another example of a forming tool 222″ is shown. The forming tool 222″ is again illustrated as being positioned above the filament mesh structure 90; however, it is to be understood that the forming tool 222″ may be moved to other locations. The forming tool 222″ may include one or more nozzles 234 and nozzle valves 236 as previously discussed but may omit a tool body that is engageable with the filament mesh structure 90.

Referring to FIG. 7, the positioning device 224 positions the forming tool 222 with respect to the filament mesh structure 90. The positioning device 224 has any suitable configuration. For instance, the positioning device 224 may be a linear actuator that is configured to move the forming tool 222 linearly or along an axis, such as between a retracted position and an extended position. In the retracted position such as is shown in FIG. 7, the forming tool 222 is separated, remotely positioned, or spaced apart from the filament mesh structure 90. In the extended position such as is shown in FIG. 9, the forming tool 222 engages and exerts force against the filament mesh structure 90. The positioning device 224 may also be provided in other configurations. For instance, the positioning device may be configured to rotate the forming tool 222 about an axis to engage or disengage the filament mesh structure 90. As another example, the positioning device may be configured to move in multiple directions or may have multiple degrees of freedom. An example of such a positioning device is shown in FIG. 13 in which the positioning device 224″ is configured as a robotic manipulator having multiple degrees of freedom.

The steam subsystem 226 is configured to provide steam 248 to the forming tool 222 or a fluid that becomes steam 248 when expelled from the nozzle 234. As such, the term “steam” includes any combination of temperature and pressure that results in steam or a vaporized fluid after exiting the nozzle. The term “steam” contemplates vaporized water as well as vaporized fluid that is other than water or in addition to water. The steam subsystem 226 has any suitable configuration. In at least one configuration, the steam subsystem 226 includes a fluid source 250, a fluid heater 252, and at least one control valve 254.

The fluid source 250 is configured to hold or provide a fluid, such as liquid water that may be converted into steam 248. The fluid source 250 is fluidly connected to the fluid heater 252 and the control valve 254 in any suitable manner, such as with a pipe, hose, or the like.

The fluid heater 252 is fluidly connected to the fluid source 250. The fluid heater 252 is configured to heat the liquid that is received from the fluid source 250 so that the fluid becomes a gas or steam 248 upon exit from the nozzle 234 or prior to exiting the nozzle 234. For instance, the fluid heater 252 may heat the liquid so that it becomes a gas after passing through the fluid heater 252 and either before or after passing through the control valve 254.

The control valve 254 controls the flow of fluid or gas to the forming tool 222. In at least one configuration, the control valve 254 is moveable between an open position and a closed position. In the open position, fluid or gas flows through the control valve 254 to the forming tool 222. In the closed position, fluid or gas does not flow through the control valve 254.

The control system 228 monitors and controls various components and subsystems of the forming system 200. For example, the control system 228 may include one or more microprocessor-based control modules or controllers 260 that may control operation of the forming tool 222, the positioning device 224, the steam subsystem 226, or combinations thereof. As such, the control system 228 controls operation of the positioning device 224, the nozzle valves 236, fluid heater 252, control valve 254, or combinations thereof.

Referring to FIG. 16, a flowchart of a method of forming a filament mesh structure 90 is shown. The method is associated with any of the forming system configurations previously discussed (e.g., forming system 200 employing an individual forming tool 222, 222′, or 222″ or more than one forming tool 222, 222′, 222″ in any combination). The flowchart encompasses three main method steps. The method may have greater or fewer steps than described below, and various steps may be performed in another order, sequentially, or simultaneously.

At block 300, the filament mesh structure 90 and the forming tool 222, 222′, and/or 222″ are aligned so that the forming tool 222, 222′, and/or 222″ may reshape the filament mesh structure 90 in one or more predetermined locations. The filament mesh structure 90 and the forming tool 222, 222′, and/or 222″ may be aligned by moving the filament mesh structure 90 with respect to the forming tool 222, 222′, and/or 222″, by moving the forming tool 222, 222′, and/or 222″ with respect to the filament mesh structure 90, or both.

At block 302, the filament mesh structure 90 is formed with the forming tool 222, 222′, and/or 222″. The filament mesh structure 90 is formed with the forming tool 222, 222′, and/or 222″ by spraying steam 248 onto the filament mesh structure of the filament mesh structure 90. The steam 248 may be directly sprayed on the filaments 52 and may not pass through an intermediate steam permeable layer, such as fabric or cloth. Spraying steam 248 onto the filament mesh structure provides multiple functions.

First, the steam 248 heats filaments 52 to allow the filaments 52 to be reformed or reshaped. More specifically, the thermal energy provided by the steam 248 heats the thermoplastic filaments 52 to a temperature that allows the thermoplastic material of the heated filaments 52 to be remolded to a different shape. The thermal energy softens or plasticizes the filaments 52 without melting the filaments 52. As such, the steam 248 is provided in a manner that keeps the temperature of the filaments 52 below the melting temperature of the thermoplastic material. As an example, the filaments 52 may be heated by the steam 248 to a temperature that is 10 to 50° C. less than the melting temperature of the thermoplastic material. Thus, a filament 52 is heated in a manner that is sufficient to allow a filament 52 to be plastically reshaped but that is insufficient to result in a new bond being formed between one filament 52 and another filament 52 or between the filament 52 and itself.

Second, the steam 248 provides a coating or barrier that helps keep the filaments 52 from adhering to or sticking to the forming tool 222, 222′, and/or 222″. The coating may be a coating of fluid or droplets of fluid that accumulate on the exterior of a filament 52. The coating acts as a lubricant or barrier that is contacted by the forming tool 222, 222′, and/or 222″ and may prevent bonding of a filament 52 to the forming tool 222, 222′, and/or 222″.

Third, in some situations the steam 248 exerts sufficient pressure to reshape one or more filaments 52 of the filament mesh structure 90.

Different amounts of steam 248 may be provided to different nozzles 234 to control reshaping of the filament mesh structure 90. For instance, a first nozzle valve 236 that controls a flow of steam to the first nozzle 234 may be controlled to exhaust a different amount of steam 248 than a second nozzle valve 236 that controls the flow of steam to a second nozzle 234.

At block 304, the flow of steam 248 is turned off and the position of the forming tool 222, 222′, and/or 222″ is reset to accommodate reshaping of another filament mesh structure 90. The flow of steam 248 may be turned off before resetting the position of the forming tool 222, 222′, and/or 222″, while the position of the forming tool 222, 222′, and/or 222″ is being reset, or after resetting the position of the forming tool 222, 222′, and/or 222″. Turning off the flow of steam 248 allows the temperature of a filament 52 to decrease such that the filament 52 cannot be remolded to a different shape without reheating.

More specific examples of method steps associated with the different forming system configurations will now be described.

Referring to FIG. 7, the forming tool 222 is shown in the retracted position as previously discussed. The filament mesh structure 90 and the forming tool 222 are aligned so that the forming tool 222 is ready reshape the filament mesh structure 90 in one or more predetermined locations. The control valve 254, the nozzle valves 236, or both are closed so that steam 248 is not sprayed by the nozzles 234. In a configuration in which the forming tool 222 includes a heater 232, the heater 232 may heat the forming tool 222 when steam 248 is not being sprayed by the nozzles 234.

Referring to FIG. 8, steam 248 is shown being sprayed by the nozzles 234. Steam 248 is sprayed by the nozzles 234 by opening the control valve 254 and one or more nozzle valves 236, if provided. The steam 248 is directed toward one or more filaments 52 of the filament mesh structure 90 to heat the filaments 52 and to help inhibit the filaments 52 from subsequently bonding to the forming tool 222 as previously discussed.

Referring to FIG. 9, the forming tool 222 is engaged with the filament mesh structure 90. The forming tool 222 is engaged with the filament mesh structure 90 by moving the filament mesh structure 90, the forming tool 222, or both as previously mentioned. Movement of the forming tool 222, the filament mesh structure 90 or both may begin before steam 248 is sprayed with the nozzles 234, after steam 248 is sprayed with the nozzles 234, or simultaneously with initiating spraying of steam 248 with the nozzles 234. It is also contemplated that the forming tool 222 may be engaged with the filament mesh structure 90 before steam 248 is sprayed with the nozzles 234, after steam 248 is sprayed with the nozzles 234, or simultaneously with initiating spraying of steam 248 with the nozzles 234.

In the configuration shown, the forming tool 222 is engaged with the filament mesh structure 90 by moving the forming tool 222 toward the filament mesh structure 90 with the positioning device 224. The filament mesh structure 90 and the forming tool 222 are sectioned in FIG. 9 to better illustrate the forming tool 222 engaged with the filament mesh structure 90. Engagement of the forming tool 222 against the filament mesh structure 90 causes the forming tool 222 to exert force on the filaments 52 that have been softened by the steam 248 and optionally by the heated forming tool 222. In response to this force, the softened filaments 52 are reshaped by the forming tool 222 and its forming features 246. For instance, softened filaments 52 are reshaped or reformed around a forming feature 246 while other filaments 52 that are not engaged by the forming tool 222 or sufficiently heated may not be reshaped. An example of reshaping filaments 52 is best shown with reference to FIGS. 14 and 15.

In FIG. 14, a magnified view of a portion of a filament mesh structure 90 is shown. A plurality of filaments 52 are shown in an initial configuration prior to being reformed or reshaped. The initial configuration may be the configuration that is provided when the filament mesh structure 90 is originally fabricated. For illustration purposes, a location on one filament 52 is designated point A while a location on a different filament 52 is designated point B. Point A is spaced apart from and does not contact point B in FIG. 14.

In FIG. 15, a magnified view of the portion of the filament mesh structure 90 is shown after being reformed or reshaped with the forming tool 222, 222′, and/or 222″. The filament 52 that includes point A has been reformed by the forming tool 222, 222′, and/or 222″ such that the filament 52 that includes point A is moved downward from the perspective shown and into contact with the filament 52 that includes point B. Although the filament 52 that includes point A has been reshaped and moved into contact with the filament 52 that includes point B, no new bond has been created between these filaments.

Referring again to FIG. 9, the forming tool 222 engages or exerts force against the filament mesh structure 90 for a sufficient period of time to allow the filaments 52 to be reformed or reshaped. As an example, the forming tool 222 may engage the filament mesh structure 90 for approximately 1 to 10 seconds although it is contemplated that period of time may be less than one second if a filament 52 are sufficiently heated prior to engagement and may be greater than 10 seconds, such as when a filament 52 is not heated prior to engagement.

Referring to FIG. 10, the forming tool 222 is reset. The forming tool 222 is reset by operating the positioning device 224 to retract the forming tool 222 to the position shown in FIG. 7. The flow of steam 248 through the nozzles 234 may be terminated before retracting the forming tool 222, after initiating retraction of the forming tool 222, or simultaneously with initiating retraction of the forming tool 222. The flow of steam 248 is terminated by closing the nozzle valves 236, the control valves 254, or both. Turning off the flow of steam 248 before raising the forming tool 222 may reduce energy consumption and may help avoid continued heating of the filaments 52 and potential over-softening or melting of the filaments 52.

The method steps associated with the configuration shown in FIGS. 11 and 12 are similar to those associated with the configuration shown in FIGS. 7-10. For example, the forming tool 222′ may begin in a retracted position with one or more valves such as the control valve 254 and/or nozzle valves 236 closed so that steam 248 is not sprayed by the nozzles 234. One or more valves are opened so that steam 248 is sprayed by the nozzles 234. The steam 248 is directed toward the location on the filament mesh structure 90 where the forming tool 222′ will engage the filament mesh structure 90. Optionally, some steam 248 may be directed toward the forming tool 222′ to heat the forming tool 222′. The steam 248 heats the filaments 52 and inhibit the filaments 52 from bonding to the forming tool 222′ as previously discussed.

The forming tool 222′ is engaged with the filament mesh structure 90 by moving the forming tool 222′, the filament mesh structure 90, or both. Engagement of the forming tool 222′ against the filament mesh structure 90 causes the forming tool 222′ to exert force against filaments 52 that have been softened by the steam 248 and optionally softened by the heated forming tool 222′. As a result, the softened filaments 52 are reshaped by the forming tool 222′. For instance, the softened filaments 52 may be reshaped or reformed around the forming feature 246′ while other filaments 52 that are not engaged by the forming tool 222′ or a reshaped filament 52 are not reshaped. The forming tool 222′ may engage the filament mesh structure 90 for a sufficient period of time to allow the filaments 52 to be reformed or reshaped as previously discussed. Finally, the forming tool 222′ may be reset by operating the positioning device 224 and terminating the flow of steam 248 through the nozzles 234.

The forming tool 222′ is depicted in FIGS. 11 and 12 has having a circular cross section; however, it is to be understood that the forming tool 222′ may have a non-circular cross section or a combination of circular and non-circular cross sections. For instance, a forming tool 222′ with a V-shaped cross section can form a V-shaped channel 174 as shown in FIG. 5G. Similarly, the forming tool 222′ in FIGS. 11 and 12 is depicted has having a straight or linear configuration; however, it is contemplated that the forming tool 222′ may have a curved or non-linear configuration or a combination of straight and curved segments or linear and non-linear segments.

A method associated with forming system 200 according to some embodiments is directed to forming a filament mesh structure (e.g., filament mesh structure 90). In various examples, the method may have greater or fewer steps than described below, and various steps may be performed in another order, sequentially, or simultaneously.

The method comprises spraying steam (e.g., steam 248) onto the filament mesh structure (e.g., filament mesh structure 90), the filament mesh structure (e.g., filament mesh structure 90) comprising filaments (e.g., filaments 52) of thermoplastic material, the filaments (e.g., filaments 52) being randomly looped and bonded, wherein spraying steam (e.g., steam 248) heats at least some of the filaments (e.g., filaments 52).

The method comprises engaging a forming tool (e.g., forming tool 222 and/or 222′) with filaments (e.g., filaments 52) that have been heated by the steam (e.g., steam 248), wherein engaging the forming tool (e.g., forming tool 222 and/or 222′) reshapes the filament mesh structure (e.g., filament mesh structure 90).

In some embodiments, the filaments (e.g., filaments 52) are heated by the steam (e.g., steam 248) to a temperature that is less than a melting temperature of the thermoplastic material.

In some embodiments, steam (e.g., steam 248) is sprayed onto the filament mesh structure (e.g., filament mesh structure 90) before engaging the forming tool (e.g., forming tool 222 and/or 222′) with the filaments (e.g., filaments 52).

In some embodiments, a liquid coating accumulates on the filaments (e.g., filaments 52) when steam (e.g., steam 248) is sprayed onto the filament mesh structure (e.g., filament mesh structure 90).

In some embodiments, the forming tool (e.g., forming tool 222 and/or 222′) contacts the liquid coating.

In some embodiments, the forming tool (e.g., forming tool 222 and/or 222′) is heated before the forming tool (e.g., forming tool 222 and/or 222′) engages the filaments (e.g., filaments 52).

In some embodiments, the steam (e.g., steam 248) heats the forming tool (e.g., forming tool 222 and/or 222′) while the forming tool engages the filaments (e.g., filaments 52).

In some embodiments, spraying steam (e.g., steam 248) includes spraying steam (e.g., steam 248) with a first nozzle (e.g., nozzle 234) and a second nozzle (e.g., nozzle 234), a first nozzle valve (e.g., nozzle valve 236) controls a flow of steam (e.g., steam 248) to the first nozzle (e.g., nozzle 234), a second nozzle valve (e.g., nozzle valve 236) controls a flow of steam (e.g., steam 248) to the second nozzle (e.g., nozzle 234), and an amount of steam (e.g., steam 248) provided to the first nozzle (e.g., nozzle 234) with the first nozzle valve (e.g., nozzle valve 236) differs from an amount of steam (e.g., steam 248) provided to the second nozzle (e.g., nozzle 234) with the second nozzle valve (e.g., nozzle valve 236).

In some embodiments, terminating spraying of steam (e.g., steam 248) and disengaging the forming tool (e.g., forming tool 222 and/or 222′) from the filament mesh structure (e.g., filament mesh structure 90) occurs after reshaping the filament mesh structure (e.g., filament mesh structure 90).

In some embodiments, steam (e.g., steam 248) heats the forming tool (e.g., forming tool 222 and/or 222′) before the forming tool (e.g., forming tool 222 and/or 222′) engages the filaments (e.g., filaments 52) and heats the forming tool (e.g., forming tool 222 and/or 222′) while the forming tool (e.g., forming tool 222 and/or 222′) engages the filaments (e.g., filaments 52).

In some embodiments, spraying steam (e.g., steam 248) includes spraying steam (e.g., steam 248) with the forming tool (e.g., forming tool 222 and/or 222′), the forming tool (e.g., forming tool 222 and/or 222′) including one or more nozzles (e.g., nozzles 234) that are fluidly connected to a manifold (e.g., 242 and/or 242′) and a tool body (e.g., tool body 230 and/or 230′) that is fixedly positioned with respect to the plurality of nozzles (e.g., nozzles 234).

In some embodiments, the plurality of nozzles (e.g., nozzles 234) do not contact the filaments (e.g., filaments 52) when spraying steam (e.g., steam 248).

In some embodiments, engaging the forming tool (e.g., forming tool 222 and/or 222′) with filaments (e.g., filaments 52) includes actuating the tool body (e.g., tool body 230 and/or 230′) at least partially into the filament mesh structure (e.g., filament mesh structure 90) to exert pressure that reshapes the filament mesh structure (e.g., filament mesh structure 90).

In some embodiments, the plurality of nozzles (e.g., nozzles 234) are spaced apart from the filament mesh structure (e.g., filament mesh structure 90) when the tool body (e.g., tool body 230′) is actuated at least partially into the filament mesh structure (e.g., filament mesh structure 90).

Referring to FIG. 13, force is exerted by the steam 248 to reshape the filaments 52 rather than by engagement of the forming tool 222″ with the filaments 52. Method steps associated with this configuration are similar to those previously discussed. First, the filament mesh structure 90 and the forming tool 222″ are aligned so that the forming tool 222″ is positioned to reshape the filament mesh structure 90 in one or more predetermined configurations. Next, steam 248 is sprayed by one or more nozzles 234. Steam 248 may be sprayed by the nozzles 234 by opening the control valve 254 and one or more nozzle valves 236, if provided. The steam 248 is directed toward one or more filaments 52 of the filament mesh structure 90 to heat the filaments 52 by a sufficient amount or for a sufficient period of time so that the filaments 52 can be reformed or reshaped. The filaments 52 are reformed by the pressure exerted by the steam 248 rather than by contact, engagement, or directly exerting force against the filaments 52 with the forming tool 222″.

The force exerted by the steam 248 against one or more filaments 52 is controlled by the control system 228, such as by controlling the position of a nozzle 234, controlling movement of a nozzle 234, controlling the flow of steam 248 (e.g., flow rate) through one or more nozzles 234, controlling the amount of time that steam 248 is exerted on a filament 52, controlling the number of nozzles or nozzle orifices that spray steam 248 toward a filament, or combinations thereof. For instance, the amount of force exerted by steam 248 may be increased by opening a nozzle valve 236 by a greater amount to increase the steam flow rate and the amount of force exerted, by holding the nozzle 234 over a filament 52 for a longer period of time, by exerting force on a filament 52 with steam from a greater number of nozzles 234, by moving a nozzle 234 closer to the filament 52 to increase the amount of steam 248 that pushes on a filament 52 (rather than being sprayed past a filament 52 or against another filament 52), or combinations thereof. Increasing the amount of force exerted on a filament 52 may result in greater filament movement and may form a deeper or wider indentation into the filament mesh structure 90.

Conversely, the amount of force exerted by the steam 248 may be reduced by closing a valve, by opening a nozzle valve 236 by a lesser amount to decrease the steam flow rate and the amount of force exerted, by holding the nozzle 234 over a filament 52 for a shorter period of time, by exerting force on a filament 52 with steam from a lesser number of nozzles 234, by moving a nozzle 234 further away from the filament 52 to decrease the amount of steam 248 that pushes on a filament 52, or combinations thereof. Decreasing the amount of force exerted on a filament may result in reduced filament movement and may form a shallower or narrower indentation into t the filament mesh structure 90. The pressure exerted by the steam may be varied as the forming tool 222″ is moved.

In some configurations, the nozzle 234 is moved by the positioning device 224″ while spraying steam 248 so that the steam 248 heats and reshapes additional filaments 52 of the filament mesh structure 90. As a result, the travel path of the nozzle 234 may be used to create a variety of contour features in the filament mesh structure 90 without contacting the filament mesh structure 90. The flow of steam 248 is interrupted or temporarily shut off when the nozzle 234 is moved over a region of the filament mesh structure 90 that is not to be reshaped.

A method associated with forming system 200 according to some embodiments is directed to forming a filament mesh structure (e.g., filament mesh structure 90). In various examples, the method may have greater or fewer steps than described below, and various steps may be performed in another order, sequentially, or simultaneously.

The method comprises spraying steam (e.g., steam 248) onto the filament mesh structure (e.g., filament mesh structure 90) with a forming tool (e.g., forming tool 222″), the filament mesh structure (e.g., filament mesh structure 90) comprised of filaments (e.g., filaments 52) of thermoplastic material that are randomly looped and bonded, wherein the forming tool (e.g., forming tool 222″) has a nozzle (e.g., nozzle 234) that sprays steam (e.g., steam 248), the steam (e.g., steam 248) heats and exerts pressure on at least some of the filaments (e.g., filaments 52) that reshapes the filament mesh structure (e.g., filament mesh structure 90), and the forming tool (e.g., forming tool 222″) does not engage the filament mesh structure (e.g., filament mesh structure 90).

In some embodiments, reshaping the filament mesh structure (e.g., filament mesh structure 90) includes moving the nozzle (e.g., nozzle 234) with respect to the filament mesh structure (e.g., filament mesh structure 90) while spraying steam (e.g., steam 248).

In some embodiments, moving the nozzle (e.g., nozzle 234) while spraying steam (e.g., steam 248) heats and reshapes additional filaments (e.g., filaments 52) of the filament mesh structure (e.g., filament mesh structure 90).

In some embodiments, steam (e.g., steam 248) is sprayed directly onto the filament mesh structure (e.g., filament mesh structure 90).

In some embodiments, the pressure exerted by the steam (e.g., steam 248) is varied as the forming tool (e.g., forming tool 222″) is moved.

In some embodiments, the forming tool (e.g., forming tool 222″) is disposed on a positioning device (e.g., positioning device 224″).

Heating filaments such as with steam allows the filament mesh structure 90 to be reshaped after its initial fabrication. As such, the filament mesh structure 90 can be reshaped from an initial configuration into another configuration that is better suited for seating applications and may improve seat occupant comfort. Reshaping is accomplished without cutting or removing material from the filament mesh structure 90, which reduces or eliminates material removal operations and reduce waste. Reshaping may be accomplished using steam rather than through the use of chemicals or softening agents. In addition, the steam may prevent filaments from sticking to a forming tool without the use of oil or other traditional lubricants, which may help reduce costs and allow a filament mesh structure to be quickly reformed to a desired shape.

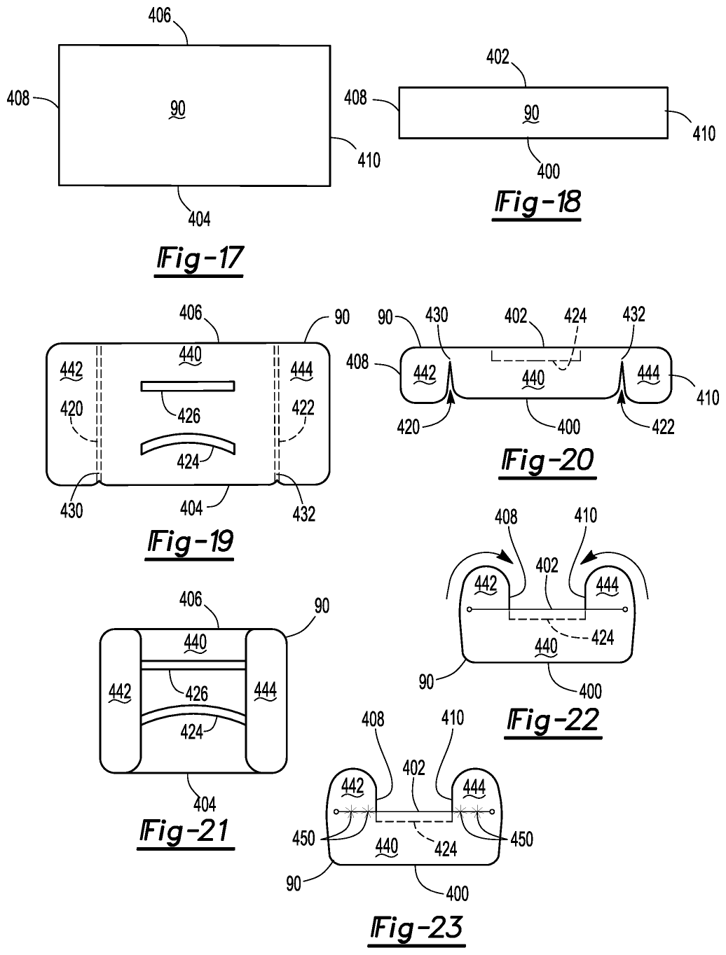

Referring to FIGS. 17-23 another example of a cushion (e.g., cushion 50) is shown. In this example the filament mesh structure 90 of the cushion is folded to produce a desired shape. Folding may be facilitated by forming a recess or trench in the filament mesh structure 90 using the cutting system 100 or the forming system 200 previously described. FIGS. 17-22 are grouped in pairs with the even-numbered figures being top views and the odd-numbered figures being side views.

Referring to FIGS. 17 and 18, a piece or block of filament mesh structure 90 is shown, such as may be produced with the manufacturing system 60. For simplicity, the filament mesh structure 90 is shown having a generally rectangular shape and rectangular cross-section. The filament mesh structure 90 has plurality of sides, including a first side 400, a second side 402, a third side 404, and a fourth side 406. In this example, the first side 400 is disposed opposite the second side 402 and the third side 404 is disposed opposite the fourth side 406. The third side 404 may be a front side and the fourth side 406 may be a back side. The filament mesh structure 90 may also include a first lateral side 408 and a second lateral side 410 that is disposed opposite the first lateral side 408.

Referring to FIGS. 19 and 20, the block of filament mesh structure 90 is shown after being formed to provide a different shape. The filament mesh structure 90 may be formed by removing material with the cutting system 100, by forming or reshaping filaments of the filament mesh structure 90 with the forming system 200, or both. It is also contemplated that the filament mesh structure 90 may be molded in a die to form or reshape filaments.

In FIG. 19, the perimeter of the filament mesh structure 90 when viewed from above is shown with a curved or contoured shape as is apparent by comparing FIGS. 17 and 18 with FIGS. 19 and 20. A curved or contoured configuration may include shaping or removing material from one or more sides of the filament mesh structure 90. In FIGS. 19 and 20, the filament mesh structure 90 is shown with a plurality of trenches, such as a first trench 420, a second trench 422, a third trench 424, and a fourth trench 426. These trenches may have linear or nonlinear configurations.

The first trench 420 and a second trench 422 are shown that are formed in the first side 400 and extend partially toward the second side 402. The first trench 420 and the second trench 422 are depicted as extending from the third side 404 to the fourth side 406.

The portion of the filament mesh structure 90 that is disposed between the bottom of the first trench 420 and the second side 402 is referred to as a first foldable connecting segment 430. The first foldable connecting segment 430 includes filaments 52 that connect the first portion 440 of the filament mesh structure 90 with a second portion 442 of the filament mesh structure 90 that is disposed on an opposite side of the first trench 420 from the first portion 440. In the configuration shown, the first portion 440 is a center portion or center seating portion of the filament mesh structure 90. The first foldable connecting segment 430 may have a linear configuration, nonlinear configuration, or combinations thereof. In the configuration shown, the first foldable connecting segment 430 is linear.

The portion of the filament mesh structure 90 that is disposed between the bottom of the second trench 422 and the second side 402 is referred to as a second foldable connecting segment 432. The second foldable connecting segment 432 includes filaments 52 that connect the first portion 440 of the filament mesh structure 90 with a third portion 444 of the filament mesh structure 90 that is disposed on an opposite side of the second trench 422 from the first portion 440. The second foldable connecting segment 432 may have a linear configuration, nonlinear configuration, or combinations thereof. In the configuration shown, the second foldable connecting segment 432 is linear.

The first trench 420 and the second trench 422 may have any suitable cross-sectional shape. In the configuration shown, the first trench 420 and the second trench 422 are shown with a generally V-shaped or slit-like configuration.

Referring primarily to FIG. 19, the third trench 424 and the fourth trench 426, if provided, are depicted as being formed in the second side 402 and extend partially through the filament mesh structure 90 toward the first side 400. Optionally, the third trench 424 and the fourth trench 426 may extend to the first foldable connecting segment 430, the second foldable connecting segment 432, or both.

It is to be understood that the filament mesh structure 90 may be inverted or flipped over from the positions shown in FIGS. 19 and 20 when the filament mesh structure is shaped. For instance, the filament mesh structure 90 may be positioned with the first side 400 facing upward to facilitate access by the cutting system 100, the forming system 200, or both.

Referring to FIGS. 21 and 22, the filament mesh structure 90 is shown after folding the filament mesh structure 90 along the first foldable connecting segment 430 the second foldable connecting segment 432.

In some configurations, folding the second portion 442 along the first foldable connecting segment 430 positions the second portion 442 upon the first portion 440. Folding the second portion 442 upon the first portion 440 may position the second portion 442 into contact with the first portion 440. For instance, folding the second portion 442 along the first foldable connecting segment 430 rotates the second portion 442 with respect to the first portion 440 such that portion of the second side 402 that is provided with the second portion 442 folds over and may fold into contact with the portion of the second side 402 that is provided with the first portion 440. Folding the second portion 442 in this manner may produce a seat cushion (e.g., cushion 32 and/or 42) in which the second portion 442 forms a first side bolster.

In some configurations, folding the third portion 444 along the second foldable connecting segment 432 positions the third portion 444 upon the first portion 440. Folding the third portion 444 upon the first portion 440 may position the third portion 444 into contact with the first portion 440. For instance, folding the third portion 444 along the second foldable connecting segment 432 rotates the third portion 444 with respect to the first portion 440 such that the portion of the second side 402 that is provided with the third portion 444 folds over and may fold into contact with the portion of the second side 402 that is provided with the first portion 440. Folding the third portion 444 in this manner may produce a seat cushion (e.g., cushion 32 and/or 42) in which the third portion 444 forms a second side bolster.

Although the first portion 440 and the second portion 442 are shown as rotating in an upward direction, this is not intended to be limiting as a foldable section may be rotated in any suitable direction based on the location of the trench and an associated foldable connecting segment. Moreover, a foldable section may be folded by a lesser angular distance in some configurations. For example, a foldable section may be folded so that opposite sides of a V-shaped slit are moved into engagement with each other.

Referring to FIG. 23, a folded portion is secured. For example, the second portion 442 is secured to the first portion 440 after folding the second portion 442, thereby holding the second portion 442 in its folded position. Similarly, the third portion 444 is secured to the first portion 440 after folding the third portion 444, thereby holding the third portion 444 in its folded position. Securing of a folded portion is represented by attachment marks 450 in FIG. 23. A folded portion, such as the second portion 442 or the third portion 444 may be secured in any suitable manner. For instance, an attachment mark 450 may represent attachment with a mechanical fastener, such as a clip, ring, hook and loop fastener, clamp or the like, with a chemical or adhesive bond, or by directly bonding one or more filaments 52 of the folded portion to the first portion 440, such as by heat staking or melting one or more filaments 52 so that new bonds are bonding points are formed on a filament 52. It is also contemplated that a folded portion may not be secured.

It is to be understood that trenches or foldable connecting segments can be provided on opposite sides of the filament mesh structure 90 to allow the filament mesh structure 90 to be folded in different directions. Thus, different portions of the cushion may be folded in different planes, along different axes or along different sides of the filament mesh structure 90.

It is also to be understood that a cushion (e.g., cushion 50) may be provided by stacking multiple layers of the filament mesh structure 90 and one or more layers may not be provided with foldable connecting segments. For instance, a foldable connecting segment may be provided in a top filament mesh structure layer but not in other layers disposed below or behind the top filament mesh structure layer. It is also to be understood that layers may be stacked laterally rather than vertically.

A cushion (e.g., cushion 32 and/or 42) comprises a filament mesh structure (e.g., filament mesh structure 90) that comprises filaments (e.g., filaments 52) of thermoplastic material, the filaments (e.g., filaments 52) being randomly looped and bonded, wherein the filament mesh structure (e.g., filament mesh structure 90) has a trench (e.g., trench 168, and/or 420 and/or 422) that extends from a first side (e.g., first side 400) of the filament mesh structure (e.g., filament mesh structure 90) toward a second side (e.g., second side 402) of the filament mesh structure (e.g., filament mesh structure 90), the second side (e.g., second side 402) being disposed opposite the first side (e.g., first side 400), the trench (e.g., trench 168, and/or 420 and/or 422) and the second side (e.g., second side 402) cooperating to define a foldable connecting segment (e.g., foldable connecting segment 430) therebetween, wherein the foldable connecting segment (e.g., foldable connecting segment 430) connects a first portion (e.g., first portion 440) of the filament mesh structure (e.g., filament mesh structure 90) with a second portion (e.g., second portion 442) of the filament mesh structure (e.g., filament mesh structure 90) and the second portion (e.g., second portion 442) is folded upon the first portion (e.g., first portion 440).

In some embodiments, the second side (e.g., second side 402) of the first portion (e.g., first portion 440) contacts the second side (e.g., second side 402) of the second portion (e.g., second portion 442).

In some embodiments, the first portion (e.g., first portion 440) is secured to the second portion (e.g., second portion 442).

In some embodiments, the cushion (e.g., cushion 32 and/or 42) is a seat cushion.

In some embodiments, the second portion (e.g., second portion 442) is a side bolster of the cushion (e.g., cushion 32 and/or 42).

In some embodiments, first portion (e.g., first portion 440) at least partially defines a center seating portion of the cushion (e.g., cushion 32 and/or 42).

A method according to some embodiments is directed to making a cushion (e.g., cushion 32 and/or 42). In various examples, the method may have greater or fewer steps than described below, and various steps may be performed in another order, sequentially, or simultaneously.

The method includes forming a trench (e.g., trench 168, and/or 420 and/or 422) in a filament mesh structure (e.g., filament mesh structure 90) that extends from a first side (e.g., first side 400) of the filament mesh structure (e.g., filament mesh structure 90) toward a second side (e.g., second side 402) of the filament mesh structure (e.g., filament mesh structure 90) that differs from the first side (e.g., first side 400), the trench (e.g., trench 168, and/or 420 and/or 422) and the second side (e.g., second side 402) cooperating to define a foldable connecting segment (e.g., foldable connecting segment 430) therebetween, and folding the filament mesh structure (e.g., filament mesh structure 90) along the foldable connecting segment (e.g., foldable connecting segment 430) therebetween.

In some embodiments, the foldable connecting segment (e.g., foldable connecting segment 430) is linear.

In some embodiments, the foldable connecting segment (e.g., foldable connecting segment 430) extends from a third side (e.g., third side 404) of the filament mesh structure (e.g., filament mesh structure 90) to a fourth side (e.g., fourth side 406) of the filament mesh structure (e.g., filament mesh structure 90) that differs from the third side (e.g., third side 404).

In some embodiments, the third side extends from the first side (e.g., first side 400) to the second side (e.g., second side 402).

In some embodiments, the fourth side (e.g., fourth side 406) extends from the first side (e.g., first side 400) to the second side (e.g., second side 402).

In some embodiments, the first side (e.g., first side 400) is disposed opposite the second side (e.g., second side 402) and the third side (e.g., third side 404) is disposed opposite the fourth side (e.g., fourth side 406).

In some embodiments, the foldable connecting segment (e.g. foldable connecting segment 430) connects a first portion (e.g., first portion 440) of the filament mesh structure (e.g., filament mesh structure 90) with a second portion (e.g., second portion 442) of the filament mesh structure (e.g., filament mesh structure 90) and folding the filament mesh structure (e.g., filament mesh structure 90) along the foldable connecting segment (e.g., foldable connecting segment 430) includes folding the second portion (e.g., second portion 442) upon the first portion (e.g., first portion 440).

In some embodiments, folding the second portion (e.g., second portion 442) upon the first portion (e.g., first portion 440) includes folding the second portion (e.g., second portion 442) into contact with the first portion (e.g., first portion 440).

In some embodiments, the second portion (e.g., second portion 442) is secured to the first portion (e.g., first portion 440) after folding the second portion (e.g., second portion 442), thereby holding the second portion (e.g., second portion 442) in a folded position.

In some embodiments, securing the second portion (e.g., second portion 442) to the first portion (e.g., first portion 440) includes bonding the first portion (e.g., first portion 440) to the second portion (e.g., second portion 442).

In some embodiments, securing the second portion (e.g., second portion 442) to the first portion (e.g., first portion 440) includes attaching the first portion (e.g., first portion 440) to the second portion (e.g., second portion 442) with a fastener.

In some embodiments, forming the trench (e.g., trench 420 and/or 422) in the filament mesh structure (e.g., filament mesh structure 90) includes cutting the filament mesh structure (e.g., filament mesh structure 90).

Clause 1. A method comprising cutting a filament mesh structure via a fluid jet.

Clause 2. The method of clause 1 wherein cutting the filament mesh structure with the fluid jet at least partially forms a cushion.

Clause 3. The method of clause 2 further comprising attaching the cushion to a frame of a seat assembly.

Clause 4. The method of clause 3 further comprising positioning a trim cover over the cushion and attaching the trim cover to the cushion, to the frame, or to the cushion and the frame.

Clause 5. The method of any one of clauses 1 to 4 further comprising forming the filament mesh structure with filaments of thermoplastic material, the filaments being randomly looped and bonded.

Clause 6. The method of clause 5 wherein forming the filament mesh structure includes extruding the thermoplastic material through a die to form the filaments and then passing the filaments through a funnel.

Clause 7. The method of clause 6 further comprising cutting the filament mesh structure after the filaments pass through the funnel.

Clause 8. The method of any one of clauses 1 to 7 further comprising controlling a travel speed of a cutting head to control a depth of a cut into the filament mesh structure.

Clause 9. The method of clause 8 further comprising decreasing the travel speed of the cutting head to increase the depth of the cut.

Clause 10. The method of any one of clauses 8 to 9 further comprising moving the cutting head closer to the filament mesh structure to increase the depth of the cut.

Clause 11. The method of any one of clauses 8 to 10 further comprising increasing a fluid pressure provided to the cutting head to increase the depth of the cut.

Clause 12. The method of any one of clauses 8 to 11 further comprising increasing a fluid flow rate of the fluid jet to increase the depth of the cut.

Clause 13. The method of any one of clauses 8 to 13 wherein cutting the filament mesh structure with the fluid jet includes positioning the cutting head remotely from the filament mesh structure such that the cutting head does not contact the filament mesh structure.

Clause 14. The method of any one of clauses 8 to 13 further comprising controlling an automation supporting the cutting head to move the cutting head along a cutting path relative to the filament mesh structure.

Clause 15. The method of clause 14 further comprising controlling the automation in at least one degree of freedom to move the cutting head along the cutting path.

Clause 16. The method of clause 14 further comprising controlling the automation in at least three degrees of freedom to move the cutting head along the cutting path.

Clause 17. The method of any one of clauses 1 to 16 further comprising cutting entirely through the filament mesh structure via the fluid jet.

Clause 18. The method of clause 1 to 17 further comprising cutting partially through the filament mesh structure via the fluid jet.

Clause 19. The method of any one of clauses 1 to 18 further comprising cutting one or more of a planar surface and a curved contour in the filament mesh structure via the fluid jet.

Clause 20. The method of any one of clauses 1 to 19 further comprising further comprising cutting one or more of an orthogonal surface, a fillet, a chamfer, and a trench in the filament mesh structure via the fluid jet.

Clause 21. A method of forming a filament mesh structure, the method comprising: spraying steam onto the filament mesh structure, the filament mesh structure comprising filaments of thermoplastic material, the filaments being randomly looped and bonded, wherein spraying steam heats at least some of the filaments; and engaging a forming tool with filaments that have been heated by the steam, wherein engaging the forming tool reshapes the filament mesh structure.

Clause 22. The method of clause 21 wherein the filaments are heated by the steam to a temperature that is less than a melting temperature of the thermoplastic material.

Clause 23. The method of clause 21 or clause 22 wherein steam is sprayed onto the filament mesh structure before engaging the forming tool with the filaments.

Clause 24. The method of any one of clauses 21 to 23 wherein a liquid coating accumulates on the filaments when steam is sprayed onto the filament mesh structure.

Clause 25. The method of any one of clause 24 wherein the forming tool contacts the liquid coating.

Clause 26. The method of any one of clauses 21 to 25 wherein the forming tool is heated before the forming tool engages the filaments.

Clause 27. The method of any one of clauses 21 to 26 wherein the steam heats the forming tool while the forming tool engages the filaments.

Clause 28. The method of any one of clauses 21 to 27 wherein spraying steam includes spraying steam with a first nozzle and a second nozzle, a first nozzle valve controls a flow of steam to the first nozzle, a second nozzle valve controls a flow of steam to the second nozzle, and an amount of steam provided to the first nozzle with the first nozzle valve differs from an amount of steam provided to the second nozzle with the second nozzle valve.

Clause 29. The method of any one of clauses 21 to 28 further comprising terminating spraying of steam and disengaging the forming tool from the filament mesh structure after reshaping the filament mesh structure.

Clause 30. The method of any one of clauses 21 to 29 wherein steam heats the forming tool before the forming tool engages the filaments and heats the forming tool while the forming tool engages the filaments.

Clause 31. The method of any one of clauses 21 to 30 wherein spraying steam includes spraying steam with the forming tool, the forming tool including a plurality of nozzles that are fluidly connected to a manifold and a tool body fixedly positioned with respect to the plurality of nozzles.

Clause 32. The method of clause 31 wherein the plurality of nozzles do not contact the filaments when spraying steam.

Clause 33. The method of clause 31 or clause 32 wherein engaging the forming tool with filaments includes actuating the tool body at least partially into the filament mesh structure to exert pressure that reshapes the filament mesh structure.

Clause 34. The method of any one of clauses 31 to 33 wherein the plurality of nozzles are spaced apart from the filament mesh structure when the tool body is actuated at least partially into the filament mesh structure.

Clause 35. A method of forming a filament mesh structure, the method comprising: spraying steam onto the filament mesh structure with a forming tool, the filament mesh structure comprised of filaments of thermoplastic material that are randomly looped and bonded, wherein the forming tool has a nozzle that sprays steam, the steam heats and exerts pressure on at least some of the filaments that reshapes the filament mesh structure, and the forming tool does not engage the filament mesh structure.

Clause 36. The method of clause 35 wherein reshaping the filament mesh structure includes moving the nozzle with respect to the filament mesh structure while spraying steam.

Clause 37. The method of clause 36 wherein moving the nozzle while spraying steam heats and reshapes additional filaments of the filament mesh structure.

Clause 38. The method of any one of clauses 35 to 37 wherein steam is sprayed directly onto the filament mesh structure.

Clause 39. The method of any one of clauses 35 to 38 wherein the pressure exerted by the steam is varied as the forming tool is moved.

Clause 40. The method of any one of clauses 35 to 39 wherein the forming tool is disposed on a positioning device.

Clause 41. The method of any one of clauses 1 to 20 further comprising: spraying steam onto the filament mesh structure, the filament mesh structure comprising filaments of thermoplastic material, the filaments being randomly looped and bonded, wherein spraying steam heats at least some of the filaments; and engaging a forming tool with filaments that have been heated by the steam, wherein engaging the forming tool reshapes the filament mesh structure.

Clause 42. The method of clause 41 wherein the filaments are heated by the steam to a temperature that is less than a melting temperature of the thermoplastic material.

Clause 43. The method of clause 41 or clause 42 wherein steam is sprayed onto the filament mesh structure before engaging the forming tool with the filaments.

Clause 44. The method of any one of clauses 41 to 43 wherein a liquid coating accumulates on the filaments when steam is sprayed onto the filament mesh structure.

Clause 45. The method of clause 44 wherein the forming tool contacts the liquid coating.

Clause 46. The method of any one of clauses 41 to 45 wherein the forming tool is heated before the forming tool engages the filaments.

Clause 47. The method of any one of clauses 41 to 46 wherein the steam heats the forming tool while the forming tool engages the filaments.

Clause 48. The method of any one of clauses 41 to 47 wherein spraying steam includes spraying steam with a first nozzle and a second nozzle, a first nozzle valve controls a flow of steam to the first nozzle, a second nozzle valve controls a flow of steam to the second nozzle, and an amount of steam provided to the first nozzle with the first nozzle valve differs from an amount of steam provided to the second nozzle with the second nozzle valve.

Clause 49. The method of any one of clauses 41 to 48 further comprising terminating spraying of steam and disengaging the forming tool from the filament mesh structure after reshaping the filament mesh structure.

Clause 50. The method of any one of clauses 41 to 49 wherein steam heats the forming tool before the forming tool engages the filaments and heats the forming tool while the forming tool engages the filaments.

Clause 51. The method of any one of clauses 41 to 50 wherein spraying steam includes spraying steam with the forming tool, the forming tool including a plurality of nozzles that are fluidly connected to a manifold and a tool body fixedly positioned with respect to the plurality of nozzles.

Clause 52. The method of clause 51 wherein the plurality of nozzles do not contact the filaments when spraying steam.

Clause 53. The method of clause 51 or clause 52 wherein engaging the forming tool with filaments includes actuating the tool body at least partially into the filament mesh structure to exert pressure that reshapes the filament mesh structure.

Clause 54. The method of any one of clauses 51 to 53 wherein the plurality of nozzles are spaced apart from the filament mesh structure when the tool body is actuated at least partially into the filament mesh structure.

Clause 55. The method of any one of clauses 1 to 20 further comprising: spraying steam onto the filament mesh structure with a forming tool, the filament mesh structure comprised of filaments of thermoplastic material that are randomly looped and bonded, wherein the forming tool has a nozzle that sprays steam, the steam heats and exerts pressure on at least some of the filaments that reshapes the filament mesh structure, and the forming tool does not engage the filament mesh structure.

Clause 56. The method of clause 55 wherein reshaping the filament mesh structure includes moving the nozzle with respect to the filament mesh structure while spraying steam.

Clause 57. The method of clause 56 wherein moving the nozzle while spraying steam heats and reshapes additional filaments of the filament mesh structure.

Clause 58. The method of any one of clauses 55 to 57 wherein steam is sprayed directly onto the filament mesh structure.

Clause 59. The method of any one of clauses 55 to 58 wherein the pressure exerted by the steam is varied as the forming tool is moved.

Clause 60. The method of any one of clauses 55 to 59 wherein the forming tool is disposed on a positioning device.

Clause 61. A method of making a cushion comprising: forming a trench in a filament mesh structure that extends from a first side of the filament mesh structure toward a second side of the filament mesh structure that differs from the first side, the trench and the second side cooperating to define a foldable connecting segment therebetween; and folding the filament mesh structure along the foldable connecting segment.

Clause 62. The method of clause 61 wherein the foldable connecting segment is linear.

Clause 63. The method of clause 61 or clause 62 wherein the foldable connecting segment extends from a third side of the filament mesh structure to a fourth side of the filament mesh structure that differs from the third side.

Clause 64. The method of clause 63 wherein the third side extends from the first side to the second side.

Clause 65. The method of clause 63 or clause 64 wherein the fourth side extends from the first side to the second side.

Clause 66. The method of any one of clauses 63 to 65 wherein the first side is disposed opposite the second side and the third side is disposed opposite the fourth side.

Clause 67. The method of any one of clauses 61 to 66 wherein the foldable connecting segment connects a first portion of the filament mesh structure with a second portion of the filament mesh structure and folding the filament mesh structure along the foldable connecting segment includes folding the second portion upon the first portion.

Clause 68. The method of clause 67 wherein folding the second portion upon the first portion includes folding the second portion into contact with the first portion.

Clause 69. The method of clause 67 further comprising securing the second portion to the first portion after folding the second portion, thereby holding the second portion in a folded position.

Clause 70. The method of clause 69 wherein securing the second portion to the first portion includes bonding the first portion to the second portion.

Clause 71. The method of clause 69 or clause 70 wherein securing the second portion to the first portion includes attaching the first portion to the second portion with a fastener.

Clause 72. The method of any one of clauses 61 to 71 wherein forming the trench in the filament mesh structure includes cutting the filament mesh structure.

Clause 73. The method of clause 72 wherein forming the trench in the filament mesh structure includes cutting the filament mesh structure with a fluid jet.

Clause 74. The method of clause 73 wherein cutting the filament mesh structure with the fluid jet at least partially forms the cushion.

Clause 75. The method of clause 74 further comprising attaching the cushion to a frame of a seat assembly.

Clause 76. The method of clause 75 further comprising positioning a trim cover over the cushion and attaching the trim cover to the cushion, to the frame, or to the cushion and the frame.

Clause 77. The method of any one of clauses 73 to 76 further comprising forming the filament mesh structure with filaments of thermoplastic material, the filaments being randomly looped and bonded.

Clause 78. The method of clause 77 wherein forming the filament mesh structure includes extruding the thermoplastic material through a die to form the filaments and then passing the filaments through a funnel.

Clause 79. The method of clause 78 further comprising cutting the filament mesh structure after the filaments pass through the funnel.

Clause 80. The method of any one of clauses 73 to 79 further comprising controlling a travel speed of a cutting head to control a depth of the cut into the filament mesh structure.

Clause 81. The method of clause 80 further comprising decreasing the travel speed of the cutting head to increase the depth of the cut.

Clause 82. The method of any one of clauses 80 to 81 further comprising moving the cutting head closer to the filament mesh structure to increase the depth of the cut.

Clause 83. The method of any one of clauses 80 to 82 further comprising increasing a fluid pressure provided to the cutting head to increase the depth of the cut.

Clause 84. The method of any one of clauses 80 to 83 further comprising increasing a fluid flow rate of the fluid jet to increase the depth of the cut.

Clause 85. The method of any one of clauses 80 to 84 wherein cutting the filament mesh structure with the fluid jet includes positioning the cutting head remotely from the filament mesh structure such that the cutting head does not contact the filament mesh structure.

Clause 86. The method of any one of clauses 80 to 85 further comprising controlling an automation supporting the cutting head to move the cutting head along a cutting path relative to the filament mesh structure.

Clause 87. The method of clause 86 further comprising controlling the automation in at least one degree of freedom to move the cutting head along the cutting path.

Clause 88. The method of clause 86 further comprising controlling the automation in at least three degrees of freedom to move the cutting head along the cutting path.

Clause 89. The method of any one of clauses 73 to 88 further comprising cutting entirely through the filament mesh structure via the fluid jet.

Clause 90. The method of clause 73 to 89 further comprising cutting partially through the filament mesh structure via the fluid jet.

Clause 91. The method of any one of clauses 73 to 90 further comprising cutting one or more of a planar surface and a curved contour in the filament mesh structure via the fluid jet.

Clause 92. The method of any one of clauses 73 to 91 further comprising further comprising cutting one or more of an orthogonal surface, a fillet, a chamfer, and a trench in the filament mesh structure via the fluid jet.

Clause 93. The method of any one of clauses 61 to 71 wherein forming the trench in the filament mesh structure includes reshaping filaments of the filament mesh structure without cutting the filaments.

Clause 94. The method of clause 93 wherein forming the trench includes spraying steam onto the filament mesh structure, the filament mesh structure comprising filaments of thermoplastic material, the filaments being randomly looped and bonded, wherein spraying steam heats at least some of the filaments; and engaging a forming tool with filaments that have been heated by the steam, wherein engaging the forming tool forms the trench.

Clause 95. The method of clause 94 wherein the filaments are heated by the steam to a temperature that is less than a melting temperature of the thermoplastic material.

Clause 96. The method of clause 94 or clause 95 wherein steam is sprayed onto the filament mesh structure before engaging the forming tool with the filaments.

Clause 97. The method of any one of clauses 94 to 96 wherein a liquid coating accumulates on the filaments when steam is sprayed onto the filament mesh structure.

Clause 98. The method of clause 97 wherein the forming tool contacts the liquid coating.

Clause 99. The method of any one of clauses 94 to 98 wherein the forming tool is heated before the forming tool engages the filaments.

Clause 100. The method of any one of clauses 94 to 99 wherein the steam heats the forming tool while the forming tool engages the filaments.

Clause 101. The method of any one of clauses 94 to 100 wherein spraying steam includes spraying steam with a first nozzle and a second nozzle, a first nozzle valve controls a flow of steam to the first nozzle, a second nozzle valve controls a flow of steam to the second nozzle, and an amount of steam provided to the first nozzle with the first nozzle valve differs from an amount of steam provided to the second nozzle with the second nozzle valve.

Clause 102. The method of any one of clauses 94 to 101 further comprising terminating spraying of steam and disengaging the forming tool from the filament mesh structure after reshaping the filament mesh structure.

Clause 103. The method of any one of clauses 94 to 102 wherein steam heats the forming tool before the forming tool engages the filaments and heats the forming tool while the forming tool engages the filaments.

Clause 104. The method of any one of clauses 94 to 103 wherein spraying steam includes spraying steam with the forming tool, the forming tool including a plurality of nozzles that are fluidly connected to a manifold and a tool body fixedly positioned with respect to the plurality of nozzles.

Clause 105. The method of clause 104 wherein the plurality of nozzles do not contact the filaments when spraying steam.

Clause 106. The method of clause 104 or clause 105 wherein engaging the forming tool with filaments includes actuating the tool body at least partially into the filament mesh structure to exert pressure that reshapes the filament mesh structure.

Clause 107. The method of any one of clauses 104 to 106 wherein the plurality of nozzles are spaced apart from the filament mesh structure when the tool body is actuated at least partially into the filament mesh structure.

Clause 108. The method of clause 93 wherein forming the trench includes spraying steam onto the filament mesh structure with a forming tool, the filament mesh structure comprised of filaments of thermoplastic material that are randomly looped and bonded, wherein the forming tool has a nozzle that sprays steam, the steam heats and exerts pressure on at least some of the filaments that reshapes the filament mesh structure to form the trench, and the forming tool does not engage the filament mesh structure.

Clause 109. The method of clause 108 wherein reshaping the filament mesh structure includes moving the nozzle with respect to the filament mesh structure while spraying steam.

Clause 110. The method of clause 109 wherein moving the nozzle while spraying steam heats and reshapes additional filaments of the filament mesh structure.

Clause 111. The method of any one of clauses 108 to 110 wherein steam is sprayed directly onto the filament mesh structure.

Clause 112. The method of any one of clauses 108 to 111 wherein the pressure exerted by the steam is varied as the forming tool is moved.

Clause 113. The method of any one of clauses 108 to 112 wherein the forming tool is disposed on a positioning device.

Clause 114. A cushion comprising: a filament mesh structure that comprises filaments of thermoplastic material, the filaments being randomly looped and bonded, wherein the filament mesh structure has a trench that extends from a first side of the filament mesh structure toward a second side of the filament mesh structure, the second side being disposed opposite the first side, the trench and the second side cooperating to define a foldable connecting segment therebetween, wherein the foldable connecting segment connects a first portion of the filament mesh structure with a second portion of the filament mesh structure and the second portion is folded upon the first portion.

Clause 115. The cushion of clause 114 wherein the second side of the first portion contacts the second side of the second portion.

Clause 116. The cushion of clause 114 or clause 115 wherein the first portion is secured to the second portion.

Clause 117. The cushion of any one of clauses 114 to 116 wherein the cushion is a seat cushion.

Clause 118. The cushion of any one of clauses 116 wherein the second portion is a side bolster of the seat cushion.

Clause 119. The cushion of clause 117 or clause 118 wherein the first portion at least partially defines a center seating portion of the cushion.

Clause 120. A cushion manufactured by the method of any of clauses 1 to 20.

Clause 121. A cushion manufactured by the method of any of clauses 21 to 34.

Clause 122. A cushion manufactured by the method of any of clauses 35 to 40.

Clause 123. A cushion manufactured by the method of any of clauses 41 to 54.

Clause 124. A cushion manufactured by the method of any of clauses 55 to 60.

Clause 125. A cushion manufactured by the method of any of clauses 61 to 113.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A method of manufacture and forming a filament mesh structure, the method comprising:
cutting a filament mesh structure with a fluid jet.

2. The method of claim 1 wherein cutting the filament mesh structure with the fluid jet at least partially forms a cushion.

3. The method of claim 2 further comprising attaching the cushion to a frame of a seat assembly.

4. The method of claim 3 further comprising positioning a trim cover over the cushion and attaching the trim cover to the cushion, to the frame, or to the cushion and the frame.

5. The method of claim 1 further comprising forming the filament mesh structure with filaments of thermoplastic material, the filaments being randomly looped and bonded.

6. The method of claim 5 wherein forming the filament mesh structure includes extruding the thermoplastic material through a die to form the filaments and then passing the filaments through a funnel.

7. The method of claim 6 further comprising cutting the filament mesh structure after the filaments pass through the funnel.

8. The method of claim 1 further comprising controlling a travel speed of a cutting head to control a depth of a cut into the filament mesh structure.

9. The method of claim 8 further comprising decreasing the travel speed of the cutting head to increase the depth of the cut.

10. The method of claim 8 further comprising moving the cutting head closer to the filament mesh structure to increase the depth of the cut.

11. The method of claim 8 further comprising increasing a fluid pressure provided to the cutting head to increase the depth of the cut.

12. The method of claim 8 further comprising increasing a fluid flow rate of the fluid jet to increase the depth of the cut.

13. The method of claim 8 wherein cutting the filament mesh structure with the fluid jet includes positioning the cutting head remotely from the filament mesh structure such that the cutting head does not contact the filament mesh structure.

14. The method of any claim 8 further comprising controlling an automation supporting the cutting head to move the cutting head along a cutting path relative to the filament mesh structure.

15. The method of claim 14 further comprising controlling the automation in at least one degree of freedom to move the cutting head along the cutting path.

16. The method of claim 14 further comprising controlling the automation in at least three degrees of freedom to move the cutting head along the cutting path.

17. The method of claim 1 further comprising cutting entirely through the filament mesh structure via the fluid jet.

18. The method of claim 1 further comprising cutting partially through the filament mesh structure via the fluid jet.

19. The method of claim 1 further comprising cutting one or more of a planar surface and a curved contour in the filament mesh structure via the fluid jet.

20. The method of claim 1 further comprising-further comprising cutting one or more of an orthogonal surface, a fillet, a chamfer, and a trench in the filament mesh structure via the fluid jet.

21-119. (canceled)

120. A cushion manufactured by the method of claim 1.

121-125. (canceled)
